(19) United States
(12) Patent Application Publication
(10) Pub. No.: US 2015/0274969 A1
(43) Pub. Date: Oct. 1, 2015

(54) LIQUID CRYSTAL ALIGNMENT AGENT AND USES THEREOF

(71) Applicant: CHI MEI CORPORATION, Tainan City (TW)

(72) Inventor: SHINRONG CHIOU, TAINAN CITY (TW)

(21) Appl. No.: 14/668,654

(22) Filed: Mar. 25, 2015

(30) Foreign Application Priority Data
Mar. 28, 2014 (TW) 103111601

(51) Int. Cl. C08L 79/08; C09K 19/56; G02F 1/1337

(52) U.S. Cl. CPC C08L 79/08; G02F 1/133723; C09K 19/56; C08L 2203/20; C08L 2203/16

(57) ABSTRACT

The invention relates to a liquid crystal alignment agent comprising a polymer composition (A) and a solvent (B); wherein the polymer composition (A) is obtained by reacting a mixture comprising a tetracarboxylic acid dianhydride component (a) and a diamine component (b). The liquid crystal alignment agent has the advantage of low moisture absorption. The invention also provides a liquid crystal alignment film made by the liquid crystal alignment agent as mentioned above and a liquid crystal display element comprising the liquid crystal alignment film.

### BACKGROUND OF THE INVENTION

1. Field of the Invention

The invention relates to a liquid crystal alignment agent, a liquid crystal alignment film and a liquid crystal display element. More particularly, the invention provides a liquid crystal alignment agent having low moisture absorption, and a liquid crystal alignment film formed thereby and a liquid crystal display element having the liquid crystal alignment film.

2. Description of the Related Art

With consumer's increasing requirement of liquid crystal display elements with wide view angles year by year, the requirements of the electrical properties and display properties of the liquid crystal display elements with wide view angles have become stricter. Among the liquid crystal display elements with wide view angles, a vertical alignment liquid crystal display element is the most widely applied. For upgrading the aforementioned properties of the vertical alignment liquid crystal display element, a liquid crystal alignment film becomes an important factor.

The liquid crystal alignment film of the vertical alignment liquid crystal display element is mainly used to regularly align liquid crystal molecules, and provides a bigger pretilt angle to the liquid crystal molecules when electrical field is not applied. The aforementioned liquid crystal alignment film is usually formed by coating a liquid crystal alignment agent having a polyamic acid polymer or a polyimide polymer on a surface of a substrate. Then, a thermal treatment and an alignment treatment are performed, thereby obtaining the liquid crystal alignment film.

Japanese Patent Publication No. 2002-162630 discloses a polyamic acid polymer used in a liquid crystal alignment agent of a vertical alignment liquid crystal display element. The polyamic acid polymer is synthesized by polymerizing a diamine compound represented by Formula (i) and a tetracarboxylic dianhydride compound.

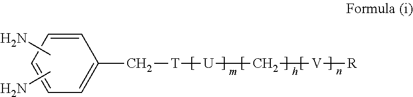

In Formula (i), T, U and V respectively represent benzene or cyclohexane, wherein a hydrogen atom in benzene or cyclohexane can be substituted by a C₁-C₃ alkyl group or a C₁-C₃ alkyl group substituted by a fluorine atom, a chlorine atom or a cyanide group; m or n respectively represents an integer from 0 to 2; h represents an integer from 0 to 5; R represents a monovalent organic group, such as a hydrogen atom, a fluorine atom, a chlorine atom or a cyanide group. When m represents 2 or n represents 2, two U or two V can be the same or different.

The aforementioned liquid crystal alignment film can provide about 90° of pretilt angle, so as to obtain good liquid crystal alignment properties. However, the liquid crystal alignment agent has high moisture absorption, and it cannot be accepted in the field.

Therefore, having a high pretilt angle and good moisture absorption at the same time is a target remained to be achieved.

### SUMMARY OF THE INVENTION

In the present invention, a specific polymer composition comprising a tetracarboxylic dianhydride component and a diamine component is provided to obtain a liquid crystal alignment agent having good moisture resistance.

Therefore, the present invention provides a liquid crystal alignment agent comprising:
a polymer composition (A) obtained by reacting a mixture comprising a tetracarboxylic dianhydride component (a) and a diamine component (b); and
a solvent (B);
wherein the diamine component (b) comprises at least one diamine compound (b-1) represented by Formula (I), and at least one diamine compound (b-2) represented by Formula (II):

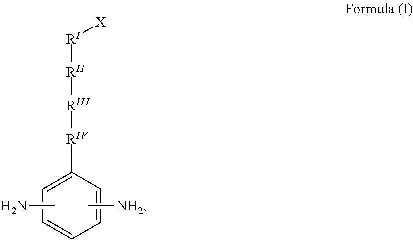

in Formula (I):
R^{I} and R^{III} each independently represent an ether group (—O—), a thioether group (—S—), a thioester group (—COS— or —SCO—) or an ester group (—COO— or —OCO—), wherein the orientation of the thioester group or the ester group is not limited;
R^{III} is a C₂-C₁₀ alkylene group;
R^{IV} is a single bond, a methylene group or an ethylene group; and
X is a C₁₇-C₄₀ monovalent organic group having a steroid frame;
in Formula (II):

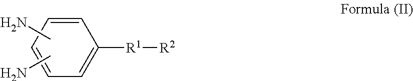

R¹ represents

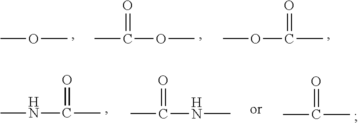

R² represents an organic group represented by Formula (II-1);

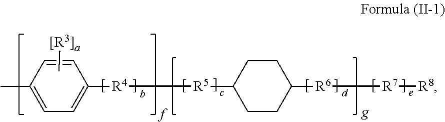

in Formula (II-1):
R³ represents a hydrogen atom, a fluorine atom or a methyl group;
R⁴, R⁵ or R⁶ each independently represent a single bond,

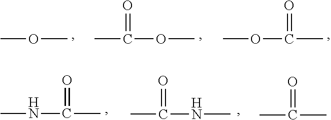

or a C₁-C₃ alkylene group;
R⁷ represents

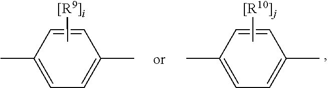

wherein R⁹ and R¹⁰ each independently represent a hydrogen atom, a fluorine atom or a methyl group;
R⁸ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
a represents 1 or 2;
b, c and d each independently represent an integer from 0 to 4;
e, f and g each independently represent an integer from 0 to 3, and e+f+g≧3;
i and j each independently represent 1 or 2; and
when R³, R⁴, R⁵, R⁶, R⁷, R⁸, R⁹ or R¹⁰ is plural, R³, R⁴, R⁵, R⁶, R⁷, R⁸, R⁹ or R¹⁰ respectively is the same or different.

The present invention also provides a liquid crystal alignment film made by the liquid crystal alignment agent as mentioned above.

The present invention also provides a liquid crystal display element comprising the liquid crystal alignment film as mentioned above.

### BRIEF DESCRIPTION OF THE DRAWINGS

FIG. 1 is a lateral-view diagram of one embodiment of a liquid crystal display element according to the present invention.

### DETAILED DESCRIPTION OF THE INVENTION

The present invention provides a liquid crystal alignment agent comprising:
a polymer composition (A) obtained by reacting a mixture comprising a tetracarboxylic dianhydride component (a) and a diamine component (b); and
a solvent (B);
wherein the diamine component (b) comprises at least one diamine compound (b-1) represented by Formula (I), and at least one diamine compound (b-2) represented by Formula (II):

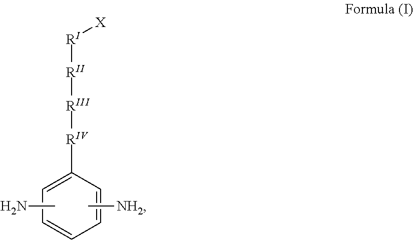

in Formula (I):
R^{I} and R^{III} each independently represent an ether group (—O—), a thioether group (—S—), a thioester group (—COS— or —SCO—) or an ester group (—COO— or —OCO—), wherein the orientation of the thioester group or the ester group is not limited;
R^{II} is a C₂-C₁₀ alkylene group;
R^{IV} is a single bond, a methylene group or an ethylene group; and
X is a C₁₇-C₄₀ monovalent organic group having a steroid frame;
in Formula (II):

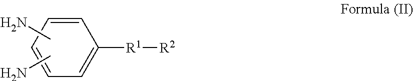

R¹ represents

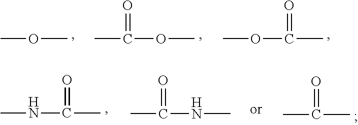

R² represents an organic group represented by Formula (II-1);

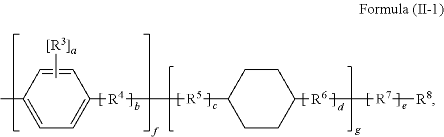

in Formula (II-1):
R³ represents a hydrogen atom, a fluorine atom or a methyl group;
R⁴, R⁵ or R⁶ each independently represent a single bond,

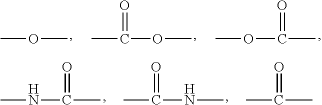

or a C₁-C₃ alkylene group;
R⁷ represents

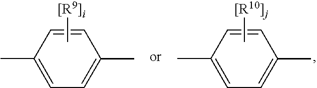

wherein R⁹ and R¹⁰ each independently represent a hydrogen atom, a fluorine atom or a methyl group;
R⁸ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
a represents 1 or 2;
b, c and d each independently represent an integer from 0 to 4;
e, f and g each independently represent an integer from 0 to 3, and e+f+g≧3;
i and j each independently represent 1 or 2; and
when R³, R⁴, R⁵, R⁶, R⁷, R⁸, R⁹ or R¹⁰ is plural, R³, R⁴, R⁵, R⁶, R⁷, R⁸, R⁹ or R¹⁰ respectively is the same or different.

The polymer composition (A) according to the invention is selected from a polyamic acid polymer, a polyimide polymer, a polyimide block-copolymer or a combination thereof. The polyimide block-copolymer is selected from a polyamic acid block-copolymer, a polyimide block-copolymer, a polyamic acid-polyimide block-copolymer or a combination thereof.

The polyamic acid polymer, polyimide polymer, and polyimide block-copolymer of the polymer composition (A) can be all obtained by reacting the mixture comprising the tetracarboxylic dianhydride component (a) and the diamine component (b). The tetracarboxylic dianhydride component (a), the diamine component (b) and a method of producing the polymer composition (A) are described in details as follows.

The tetracarboxylic dianhydride component (a) can be selected from an aliphatic tetracarboxylic dianhydride compound, an alicyclic tetracarboxylic dianhydride compound, an aromatic tetracarboxylic dianhydride compound, the tetracarboxylic dianhydride component (a) represented by Formulae (a-1) to (a-6) or the like.

Examples of the aliphatic tetracarboxylic dianhydride compound include but are not limited to tetracarboxylic dianhydride ethane, tetracarboxylic dianhydride butane or the like.

Examples of the alicyclic tetracarboxylic dianhydride compound include but are not limited to 1,2,3,4-tetracarboxylic dianhydride cyclobutane, 1,2-dimethyl-1,2,3,4-tetracarboxylic dianhydride cyclobutane, 1,3-dimethyl-1,2,3,4-tetracarboxylic dianhydride cyclobutane, 1,3-dichloro-1,2,3,4-tetracarboxylic dianhydride cyclobutane, 1,2,3,4-tetramethyl-1,2,3,4-tetracarboxylic dianhydride cyclobutane, 1,2,3,4-tetracarboxylic dianhydride cyclopentane, 1,2,4,5-tetracarboxylic dianhydride cyclohexane, 3,3′,4,4′-tetracarboxylic dianhydride dicyclohexane, cis-3,7-dibutylcycloheptyl-1,5-diene-1,2,5,6-tetracarboxylic dianhydride, 2,3,5-tricarboxycyclopentyl acetic dianhydride, dicyclo[2.2.2]-octyl-7-ene-2,3,5,6-tetracarboxylic dianhydride or the like.

Examples of the aromatic tetracarboxylic dianhydride compound include but are not limited to 3,4-dicarboxy-1,2,3,4-tetrahydronaphthalene-1-succinic acid dianhydride, pyromellitic dianhydride, 2,2′,3,3′-benzophenone tetracarboxylic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylethane tetracarboxylic dianhydride, 3,3′,4,4′-dimethyl diphenylsilane tetracarboxylic dianhydride, 3,3′,4,4′-tetraphenylsilane tetracarboxylic dianhydride, 1,2,3,4-furan tetracarboxylic dianhydride, 2,3,3′,4′-biphenylether tetracarboxylic dianhydride, 3,3′,4,4′-biphenylether tetracarboxylic dianhydride, 4,4′-bis(3,4-dicarboxyphenoxy)diphenylsulfide dianhydride, 2,3,3′,4′-biphenylsulfide tetracarboxylic dianhydride, 3,3′,4,4′-biphenylsulfide tetracarboxylic dianhydride, 4,4′-bis(3,4-dicarboxyphenoxyl)diphenylsulfone dianhydride, 4,4′-bis(3,4-dicarboxyphenoxyl)diphenylpropane dianhydride, 3,3′,4,4′-perfluoroisopropylidene diphenyl dicarboxylic dianhydride, 2,2′3,3′-biphenyl tetracarboxylic dianhydride, 2,3,3′,4′-biphenyl tetracarbxylic dihydrate, 3,3′,4,4′-biphenyl tetracarboxylic dianhydate, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, glycol-bis(anhydrotrimelitate), propanediol-bis(anhydrotrimelitate), 1,4-butanediol-bis(anhydrotrimelitate), 1,6-hexyanediol-bis(anhydrotrimelitate), 1,8-octanediol-bis(anhydrotrimelitate), 2,2-bis(4-hydroxyphenyl)propane-bis(anhydrotrimelitate), 2,3,4,5-tetrahydrofurantetracarboxylic dianhydride, 1,3,3a,4,5,9b-hexahydro-5-(tetrahydro-2,5-dioxofuran-3-yl)naphtho[1,2-c]furan-1,3-dione, 1,3,3a,4,5,9b-hexahydro-5-methyl-5-(tetrahydro-2,5-dioxofuran-3-yl)naphtho[1,2-c]furan-1,3-dione, 1,3,3 a,4,5,9b-hexahydro-5-ethyl-5-(tetrahydro-2,5-dioxofuran-3-yl)naphtho[1,2-c]furan-1,3-dione, 1,3,3a,4,5,9b-hexahydro-7-methyl-5-(tetrahydro-2,5-dioxofuran-3-yl)naphtho[1,2-c]furan-1,3-dione, 1,3,3a,4,5,9b-hexahydro-7-ethyl-5-(tetrahydro-2,5-dioxofuran-3-yl)naphtho[1,2-c]furan-1,3-dione, 1,3,3a,4,5,9b-hexahydro-8-methyl-5-(tetrahydro-2,5-dioxofuran-3-yl)naphtho[1,2-c]furan-1,3-dione, 1,3,3a,4,5,9b-hexahydro-8-ethyl-5-(tetrahydro-2,5-dioxofuran-3-yl)naphtho[1,2-c]furan-1,3-dione, 1,3,3a,4,5,9b-hexahydro-5,8-dimethyl-5-(tetrahydro-2,5-dioxofuran-3-yl)naphtho[1,2-c]furan-1,3-dione, 5-(2,5-dioxotetrahydrofuran)-3-methyl-3-cyclohexene-1,2-dicarboxylic dianhydride or the like.

The tetracarboxylic dianhydride component (a) represented by Formulae (a-1) to (a-6) are shown as follows:

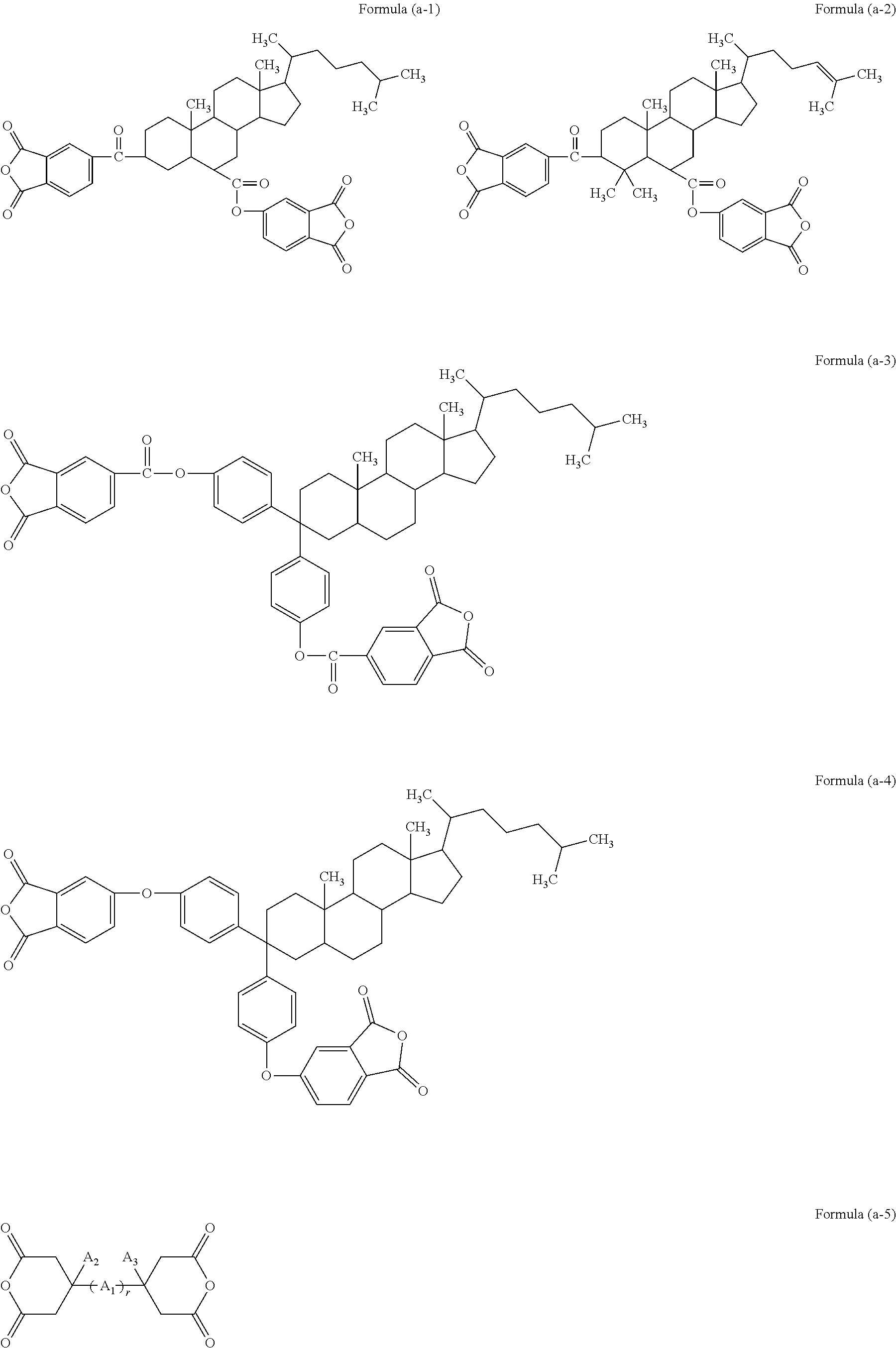

in Formula (a-5), A₁ represents a divalent group having an aromatic ring; r represents an integer from 1 or 2; A₂ and A₃ can be the same or different, and A₂ and A₃ respectively represent a hydrogen atom or an alkyl group. Preferably, the tetracarboxylic dianhydride component (a) represented by Formula (a-5) can be selected from a compound represented by Formulae (a-5-1) to (a-5-3):

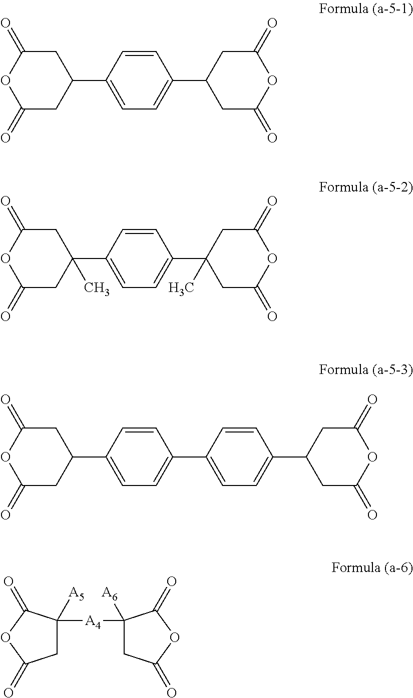

in Formula (a-6), A₄ represents a divalent group having an aromatic ring; A₅ and A₆ can be the same or different, and A₅ and A₆ respectively represent a hydrogen atom or an alkyl group. Preferably, the tetracarboxylic dianhydride component (a) represented by Formula (a-6) can be selected from a compound represented by Formula (a-6-1):

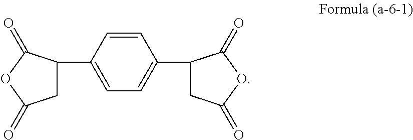 [SMILES: O=C1CC(c2ccc(C3CC(=O)OC3=O)cc2)C(=O)O1]

Preferably, the tetracarboxylic dianhydride component (a) includes but is not limited to 1,2,3,4-cyclobutane tetracarboxylic dianhydride, 1,2,3,4-cyclopentane tetracarboxylic dianhydride, 2,3,5-tricarboxycyclopentane acetic acid dianhydride, 1,2,4,5-cyclohexane tetracarboxylic dianhydride, 3,4-dicarboxy-1,2,3,4-tetrahydronaphthalene-1-succinic acid dianhydride, pyromellitic dianhydride, 3,3′,4,4′-benzophenone tetracarboxylic dianhydride and 3,3′,4,4′-biphenylsulfone tetracarboxylic dianhydride. The aforementioned tetracarboxylic dianhydride component (a) can be used alone or a combination of two or more.

The diamine component (b) comprises at least one diamine compound (b-1) represented by Formula (I), at least one diamine compound (b-2) represented by Formula (II) and an other diamine compound (b-3).

The diamine compound (b-1) according to the invention is represented by Formula (I):

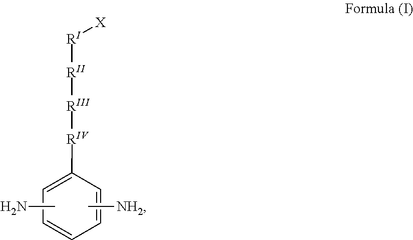

in Formula (I):
R^{I} and R^{III} each independently represent an ether group, a thioether group, a thioester group or an ester group, wherein the orientation of the thioester group or the ester group is not limited; in other word, the term “an ester group” as used herein can be

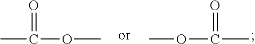

the term “a thioether group” as used herein can be

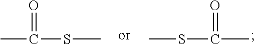

preferably R^{I} and R^{III} are an ether group or an ester group;
R^{II} is a C₂-C₁₀ alkylene group; preferably is a C₂-C₄ alkylene group;
R^{IV} is a single bond, a methylene group or an ethylene group; preferably is a single bond or a methylene group; and
X is a C₁₇-C₄₀ monovalent organic group having a steroid frame, wherein the steroid frame refers to a cyclopentano-perhydro phenanthrene frame, wherein one or more carbon-carbon bonds of the frame can be a double bond. Examples of the steroid frame are represented by Formulae (X-1) to (X-4) as follows:

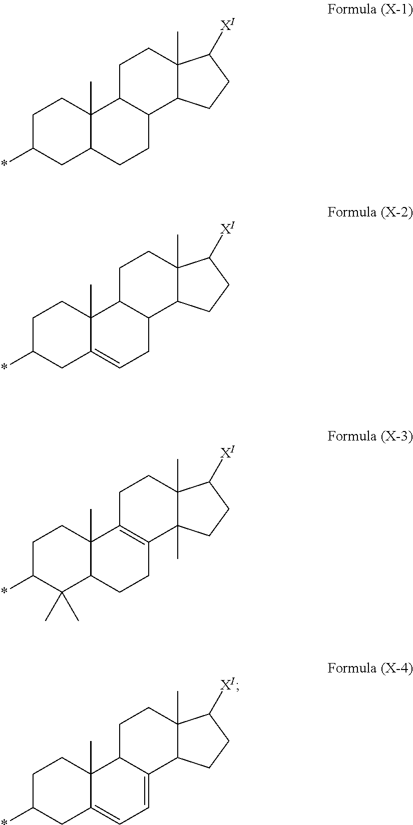

X^{I} independently represents a structure as the following:

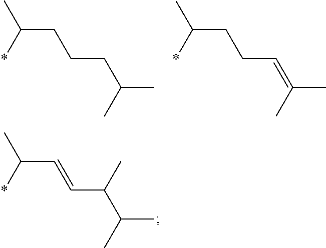

wherein + represents a bonding bond; and * represents a bonding bond.

Examples of X are represented by Formulae (X-1-1), (X-2-1), (X-3-1) and (X-4-1);

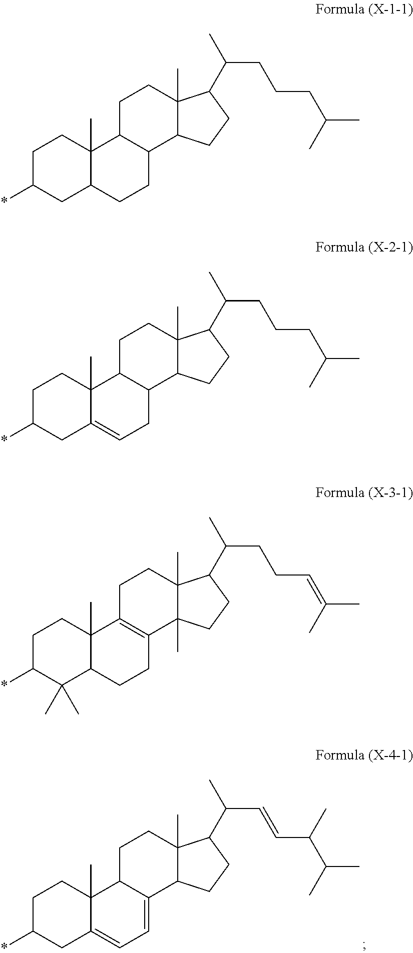 [SMILES: *C1CCC2(C)C(CCC3C2CCC2(C)C(C(C)CCCC(C)C)CCC32)C1 ; *C1CCC2(C)C(=CCC3C2CCC2(C)C(C(C)CCCC(C)C)CCC32)C1 ; *C1CCC2(C)C3=C(CCC2C1(C)C)C1(C)CCC(C(C)CCC=C(C)C)C1(C)CC3 ; *C1CCC2(C)C(=CC=C3C2CCC2(C)C3CCC2C(C)/C=C/C(C)C(C)C)C1]

wherein * represents a bonding bond.

Examples of Formula (I) are represented by Formulae (I-1) to (I-29);

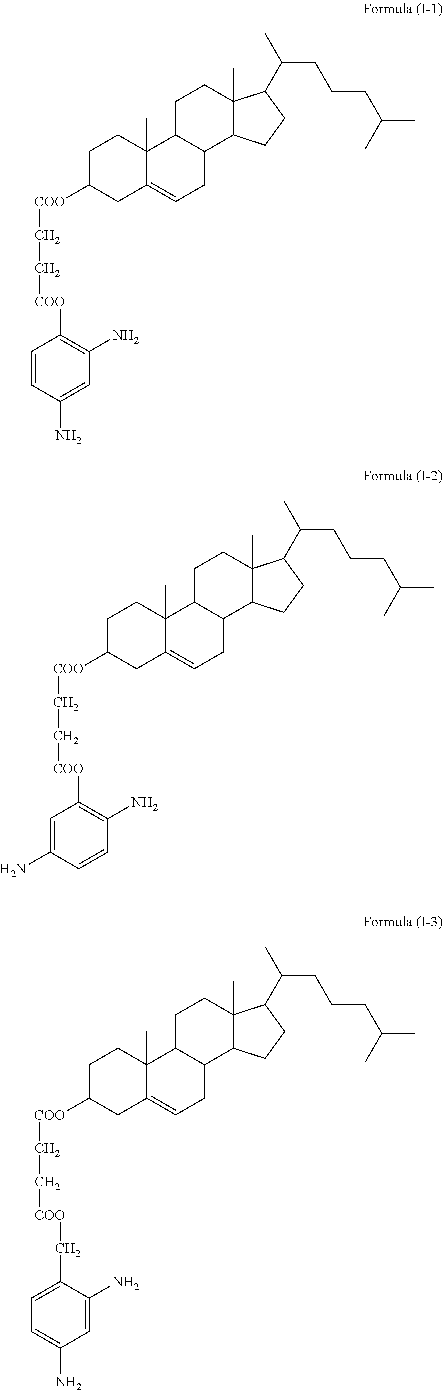

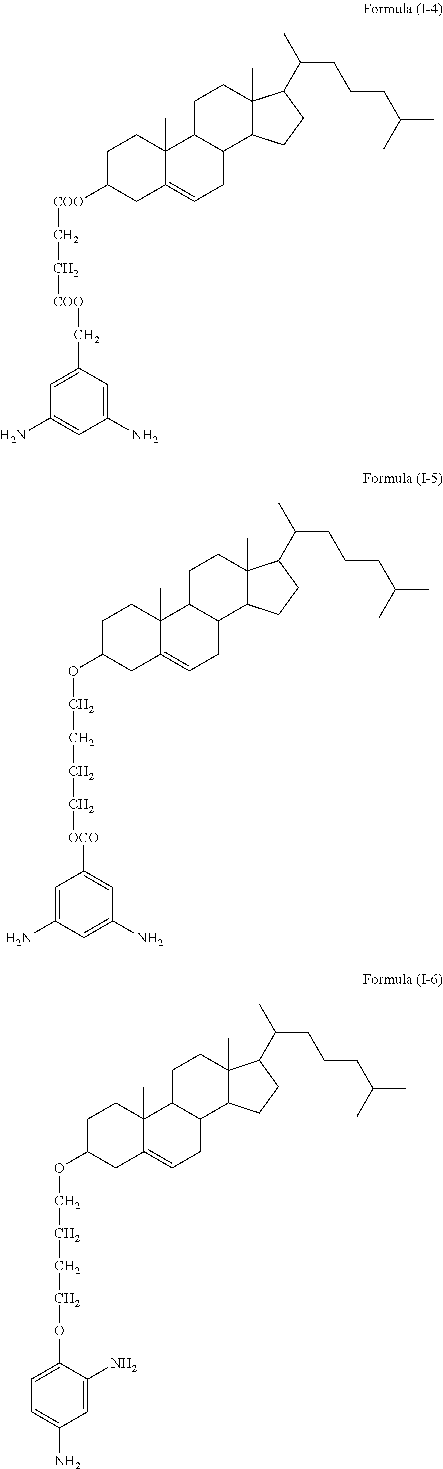

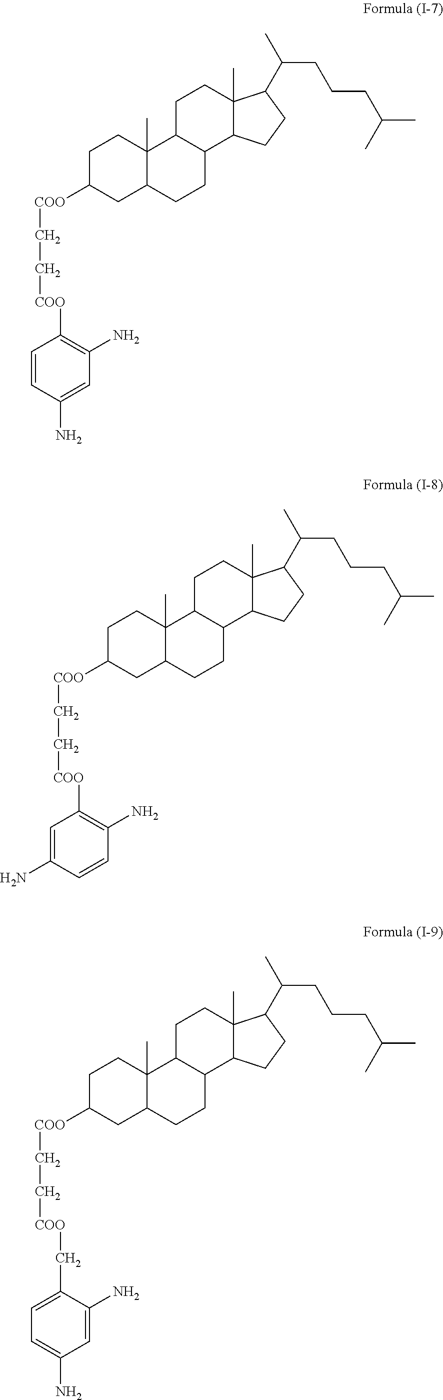

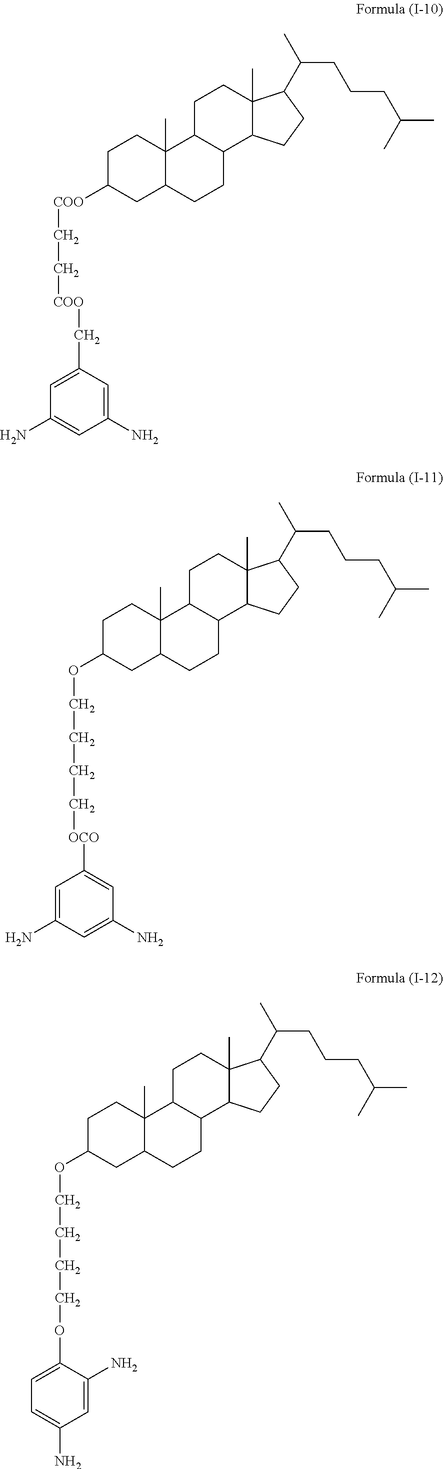

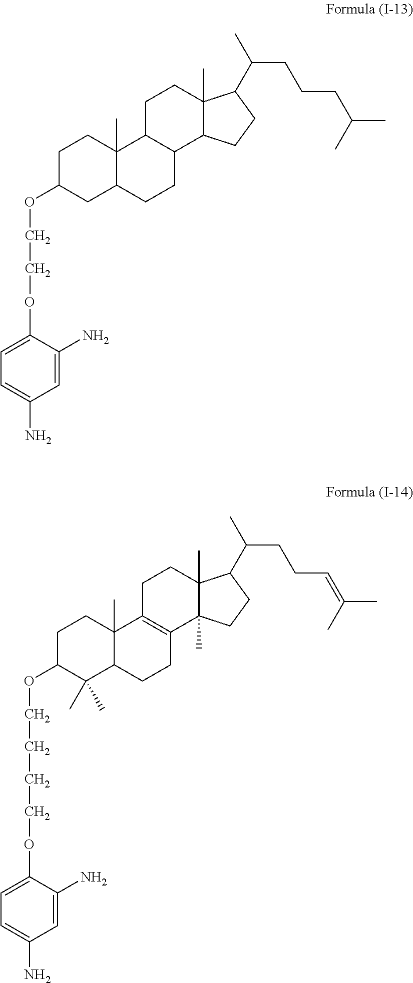

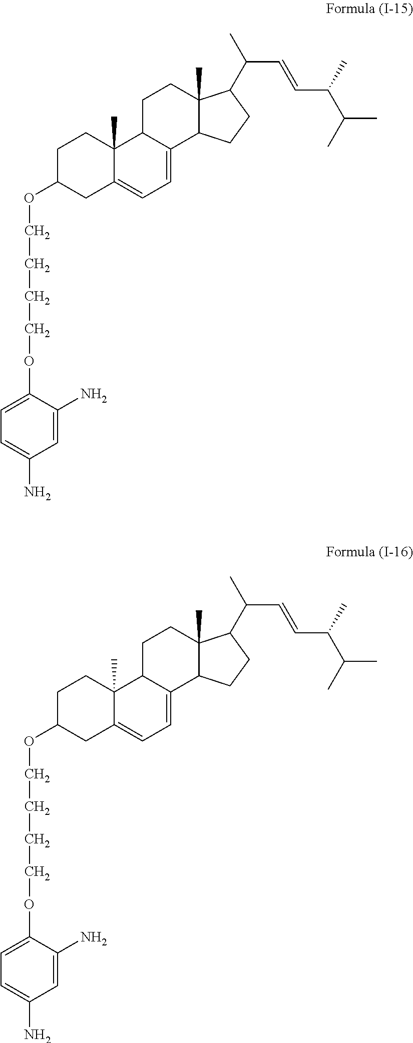 [SMILES: CC(/C=C/[C@H](C)C(C)C)C1CCC2C3=CC=C4CC(OCCCCOc5ccc(N)cc5N)CC[C@]4(C)C3CC[C@@]21C ; CC(/C=C/[C@H](C)C(C)C)C1CCC2C3=CC=C4CC(OCCCCOc5ccc(N)cc5N)CC[C@@]4(C)C3CC[C@@]21C]

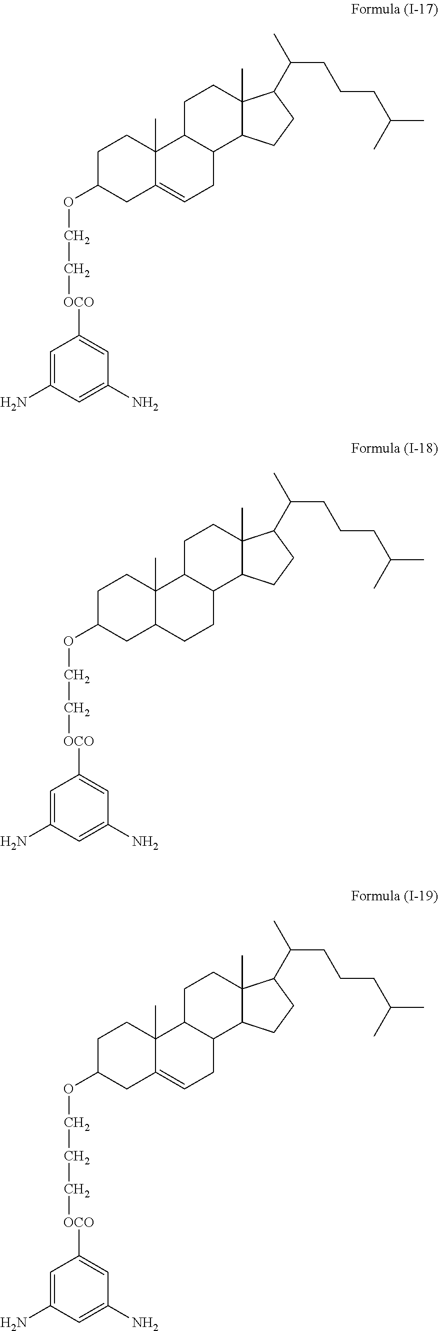

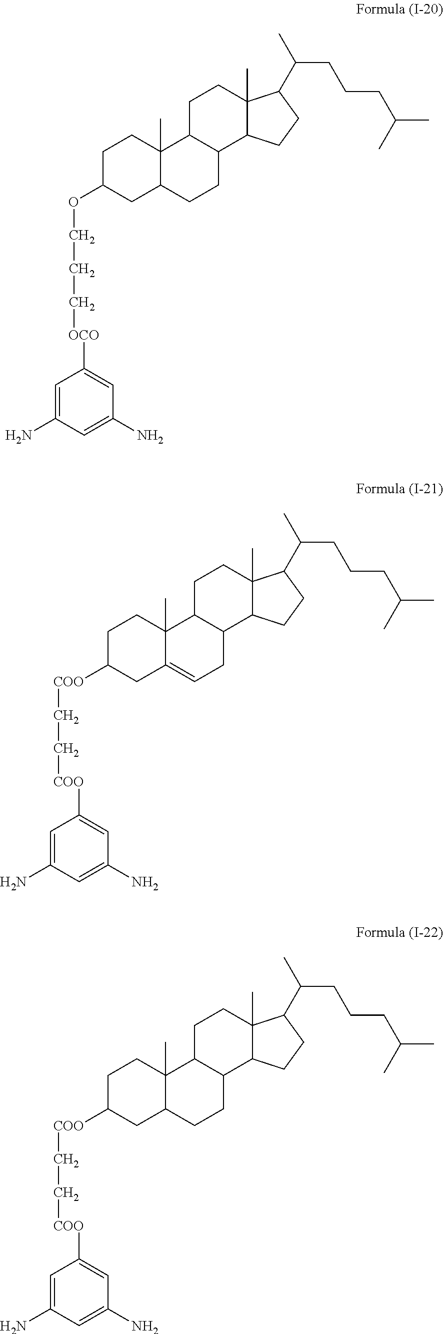

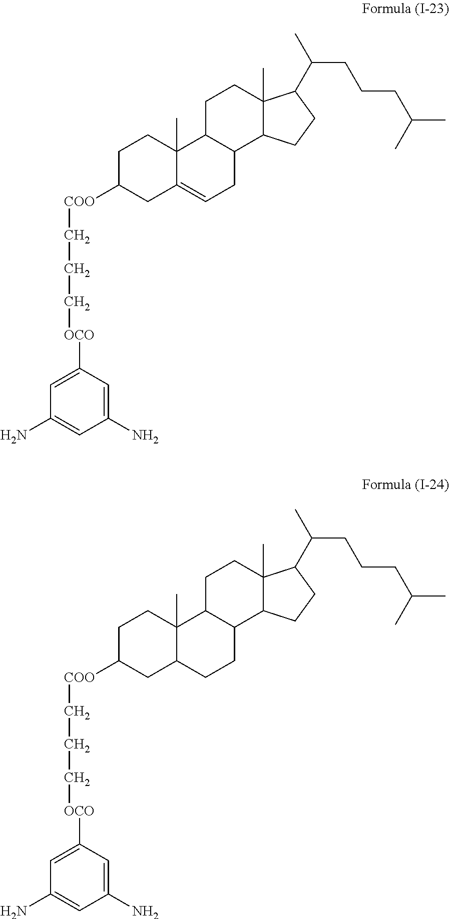

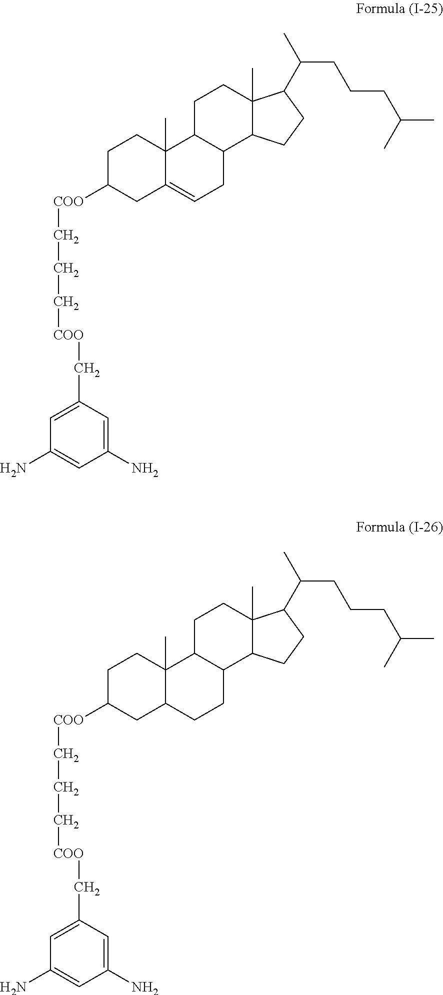

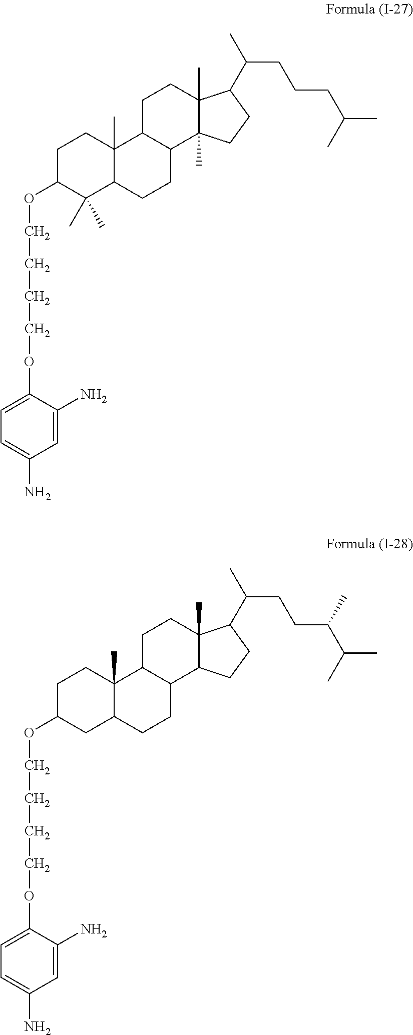

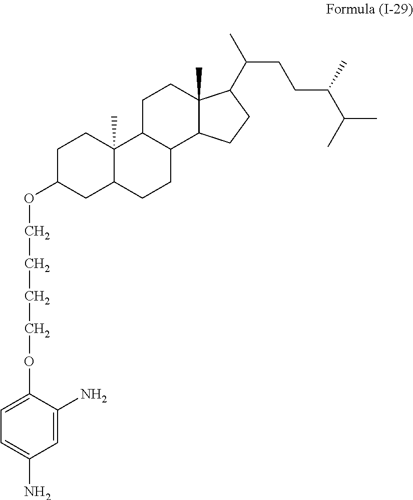 [SMILES: CC(CC[C@H](C)C(C)C)C1CCC2C3CCC4CC(OCCCCOc5ccc(N)cc5N)CC[C@@]4(C)C3CC[C@]12C]

The compound represented by Formula (I) can be synthesized by conventional methods of organic chemistry.

For example, the compound represented by Formula (I-1), (I-2), (I-7) or (I-8) is synthesized by carrying out an addition reaction by reacting succinic anhydride with cholesterol or cholestanol, respectively; obtaining acyl chloride by thionyl chloride, for example; reacting acyl chloride and dinitrophenol in the presence of more equivalents of alkaline based on acyl chloride; and then carrying out a reduction reaction using an appropriate reducing agent, such as Tin chloride, to complete the above-mentioned synthesis.

The compound represented by Formula (I-3), (I-4), (I-9) or (I-10) is synthesized by carrying out an addition reaction by reacting succinic anhydride with cholesterol or cholestanol, respectively; carrying out an esterification reaction by reacting the above-mentioned adduct with dinitrobenzoyl chloride in the presence of potassium carbonate; and then carrying out a reduction reaction using an appropriate reducing agent, such as Tin chloride, to complete the above-mentioned synthesis.

The compound represented by Formula (I-5) or (I-11) is synthesized by carrying out a tosylation reaction by reacting tosyl chloride with cholesterol or cholestanol, respectively to obtain tosylated cholesterol or tosylated cholestanol; forming an ether group by reacting dinitrobenzoylacylbutanediolmonoester, which is obtained by reacting butanediol and excess dinitrobenzoyl acyl chloride in the presence of alkaline, with the above-mentioned tosylated cholesterol with heat and an appropriate organic solvent; and then carrying out a reduction reaction using an appropriate reducing agent, such as Tin chloride, to complete the above-mentioned synthesis is completed.

The compound represented by Formula (I-6) or (I-12) is synthesized by carrying out an addition reaction by reacting succinic anhydride with cholesterol or cholestanol, respectively; reducing a carbonyl group of the above-mentioned adduct to a methylene group by aluminum lithium in the presence of alkaline such as potassium tert-butoxide; then carrying out a reduction reaction by reacting the above-mentioned reducing substance with 2,4-dinitrochlorobenzene; or then forming an ether group by reacting 1-(4-hydroxybutoxy)-2,4-dinitrobenzene, which is obtained by reacting 2,4-dinitrochlorobenzene and excess butanediol in the presence of alkaline, with the above-mentioned tosylated cholesterol or tosylated cholestanol with heat and an appropriate organic solvent; and then carrying out a reduction reaction using an appropriate reducing agent, such as Tin chloride, to complete the above-mentioned synthesis.

The compound represented by Formula (I-13) is synthesized by forming an ether group by reacting 1-(4-hydroxybutoxy)-2,4-dinitrobenzene, which is obtained by 2,4-dinitrochlorobenzene with excess ethylene glycol in the presence of alkaline such as potassium tert-butoxide, with the above-mentioned tosylated cholestanol with heat and an appropriate organic solvent, and then carrying out a reduction reaction using an appropriate reducing agent, such as Tin chloride, to complete the above-mentioned synthesis.

The compound represented by Formula (I-14), (I-15) or (I-16) is synthesized by using lanosterol, lumisterol or ergosterol as a starting material, respectively, and the synthesis is completed according to the synthesis method of Formula (I-6).

The compound represented by Formula (I-17) or (I-18) is synthesized by tosylating cholesterol or cholestanol, respectively, with methanesulfonyl chloride; carrying out a substitution reaction with excess ethylene glycol to synthesize an single ether compound; in the presence of alkaline, synthesizing a dinitro compound by reacting the above-mentioned single ether compound with 3,5-dinitrobenzoyl chloride; and then carrying out a reduction reaction using an appropriate reducing agent, such as palladium carbon to complete the above-mentioned synthesis.

The compound represented by Formula (I-19) or (I-20) is synthesized by forming alkoxide by reacting potassium hydride with cholesterol or cholestanol, respectively; forming an ether group with excess dibromopropane to obtain an intermediate; in the presence of potassium carbonate, synthesizing a dinitro compound by reacting the intermediate with 3,5-dinitrobenzoic acid; and then carrying out a reduction reaction using an appropriate reducing agent, such as palladium carbon to complete the above-mentioned synthesis.

The compound represented by Formula (I-21) or (I-22) is synthesized by carrying out an addition reaction by reacting succinic anhydride with cholesterol or cholestanol, respectively; reacting the adduct with 3,5-(N,N-diallyl)aminophenol in the presence of N,N-dicyclohexylcarbodiimide; and then removing an allyl group by 1,3-dimethylbarbituric acid and tetrakistriphenyl phosphinepalladium to complete the above-mentioned synthesis.

The compound represented by Formula (I-23) or (I-24) is synthesized by carrying out an addition reaction by reacting succinic anhydride with cholesterol or cholestanol, respectively; reducing a carbonyl group to alcohol to obtain an intermediate in the presence of borane-oxolane complex; synthesizing a dinitro compound by reacting the above-mentioned intermediate with 3,5-dinitrobenzoyl chloride in the presence of alkaline; and then carrying out a reduction reaction using an appropriate reducing agent, such as palladium carbon to complete the above-mentioned synthesis.

The compound represented by Formula (I-25) or (I-26) is synthesized by carrying out an addition reaction by reacting ketoglutarate anhydride substituting for succinate with cholesterol or cholestanol, respectively, and then carrying out the synthesis according to the synthesis method of Formula (I-4) or (I-10).

The compound represented by Formula (I-27), (I-28) or (I-29) is synthesized by hydrogenating lanosterol, lumisterol or ergosterol using an appropriate hydrogenation catalyst as a starting material, and then carrying out the synthesis according to the synthesis method of Formula (I-14), (I-15) or (I-16).

Based on 100 moles of the used amount of the diamine component (b), the used amount of the diamine compound (b-1) represented by Formula (I) is from 10 to 50 moles; preferably is from 10 to 40 moles; more preferably is from 15 to 35 moles.

The diamine compound (b-2) is represented by Formula (II):

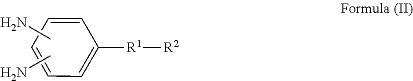

R¹ represents

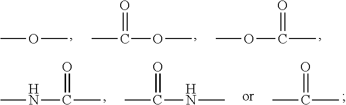

R² represents an organic group represented by Formula (II-1);

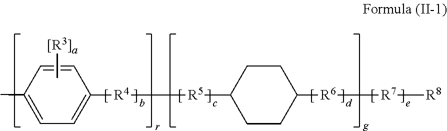

in Formula (II-1):
R³ represents a hydrogen atom, a fluorine atom or a methyl group;
R⁴, R⁵ or R⁶ each independently represents a single bond,

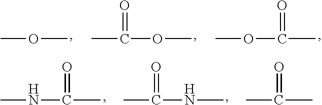

or a C₁-C₃ alkylene group;

R⁷ represents

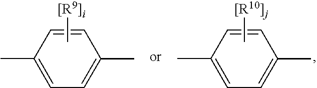

wherein R⁹ and R¹⁰ each independently represent a hydrogen atom, a fluorine atom or a methyl group;
R⁸ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
a represents 1 or 2;
b, c and d each independently represent an integer from 0 to 4;
e, f and g each independently represent an integer from 0 to 3, and e+f+g≧3;
i and j each independently represent 1 or 2; and
when R³, R⁴, R⁵, R⁶, R⁷, R⁸, R⁹ or R¹⁰ is plural, R³, R⁴, R⁵, R⁶, R⁷, R⁸, R⁹ or R¹⁰ respectively is the same or different.

Examples of the diamine compound (b-2) represented by Formula (II) are shown as Formulae (II-2) to (II-9):

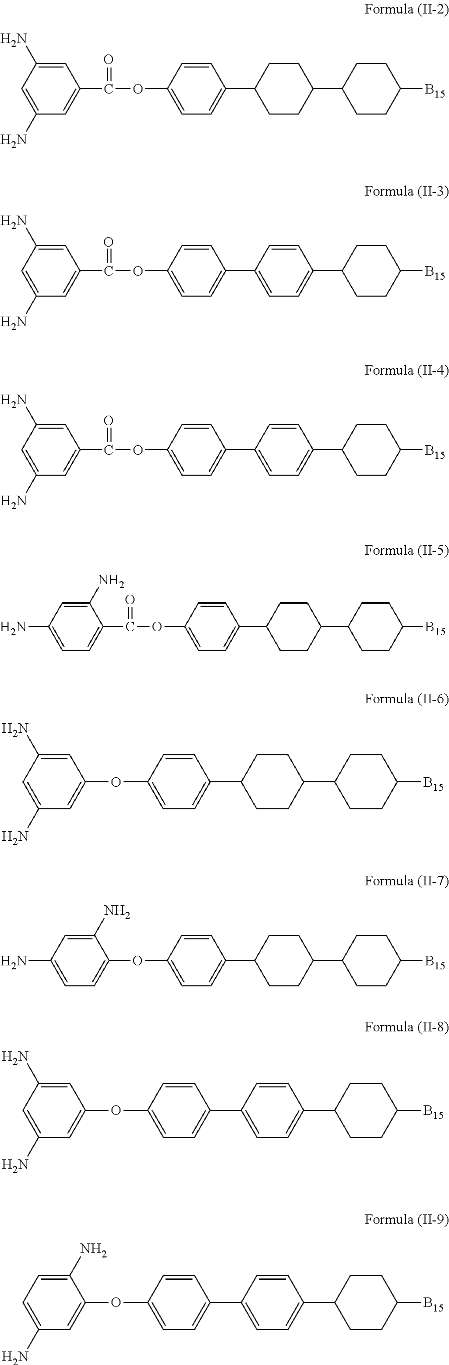

In Formulae (II-2) to (II-9), preferably B₁₅ represents a hydrogen atom, a C₁-C₁₀ alkyl group or a C₁-C₁₀ alkoxy group.

Preferably, the diamine compound (b-2) represented by Formula (II) is the diamine compound (b-2) represented by Formulae (II-10) to (II-14):

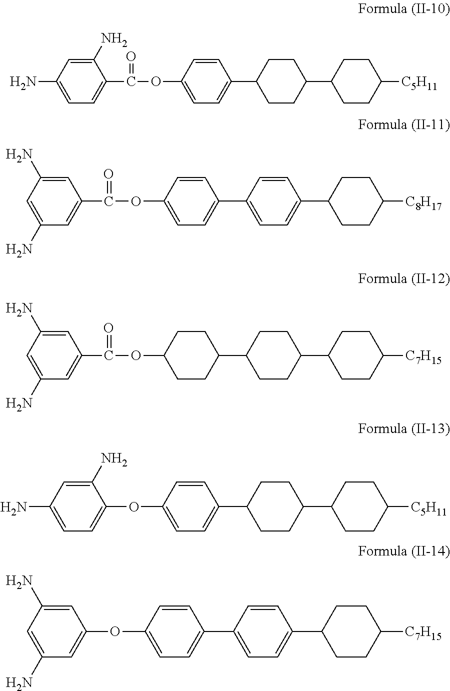

The aforementioned diamine compound (b-2) can be used alone or a combination of two or more.

Based on 100 moles of the used amount of the diamine component (b), the used amount of the diamine compound (b-2) represented by Formula (II) is from 1 to 15 moles; preferably is from 2 to 12 moles; more preferably is from 3 to 10 moles.

In the liquid crystal alignment agent according to the present invention, if the diamine compound (b-1) and the diamine compound (b-2) are not both contained in the diamine component (b), the liquid crystal alignment agent has poor low moisture absorption.

Examples of the molar ratio of the diamine compound (b-1) represented by Formula (I) and the diamine compound (b-2) represented by Formula (II) is 2 to 8; preferably is 3 to 8; more preferably is 3 to 7. If the molar ratio of the diamine compound (b-1) represented by Formula (I) and the diamine compound (b-2) represented by Formula (II) [(b-1)/(b-2)] ranges from 2 to 8, the liquid crystal alignment agent has good low moisture absorption.

The diamine component (b) further comprises an other diamine compound (b-3), wherein the other diamine compound (b-3) includes but is not limited to 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 4,4′-diaminoheptane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxyl)ethane, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6.2.1.0^{2,7})-undecenoyl dimethyldiamine, 4,4′-methylenebis(cyclohexylamine), 4,4′-diaminodiphenylmethane, 4,4′-diaminodiphenylethane, 4,4′-diaminodiphenylsulfone, 4,4′-diaminobenzanilide, 4,4′-diaminodiphenylether, 3,4′-diaminodiphenylether, 1,5-diaminonaphthalene, 5-amino-1-(4′-aminophenyl)-1,3,3-trimethylindane, 6-amino-1-(4-aminophenyl)-1,3,3-trimethylindane, hexahydro-4,7-methanoindanylenedimethylenediamine, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxyl)benzene, 1,3-bis(4-aminophenoxy)benzene, 1,3-bis(3-aminophenoxyl)benzene, 9,9-bis(4-aminophenyl)-10-hydroanthracene, 9,10-bis(4-aminophenyl)anthracene, 2,7-diaminofluorene, 9,9-bis(4-aminophenyl)fluorene, 4,4′-methylene-bis(2-chloroaniline), 4,4′-(p-phenyleneisopropylene)bisaniline, 4,4′-(m-phenylene isopropylene)bisaniline, 2,2′-bis[4-(4-amino-2-trifluoromethyl phenoxy)phenyl]hexafluoropropane, 4,4′-bis[(4-amino-2-trifluoro)phenoxy]octafluorophenyl benzene, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, or the other diamine compound (b-3) represented by Formulae (III-1) to (III-25).

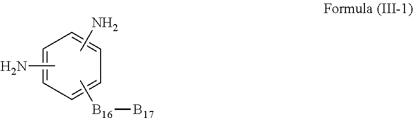

In Formula (III-1), B₁₆ represents

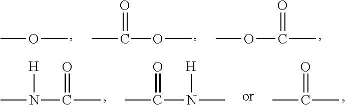

B₁₇ represents a steroid-containing group, a trifluoro methyl group, a fluoro group, a C₂-C₃₀ alkyl group or an monovalent nitrogen-containing cyclic group derived from pyridine, pyrimidine, triazine, piperidine, piperazine or the like.

Preferably, the other diamine compound (b-3) is 2,4-diaminophenyl ethyl formate, 3,5-diaminophenyl ethyl formate, 2,4-diaminophenyl propyl formate, 3,5-diaminophenyl propyl formate, 1-dodecoxy-2,4-diaminobenzene, 1-hexadecoxy-2,4-diaminobenzene, 1-octadecoxy-2,4-diaminobenzene or the other diamine compound (b-3) represented by Formulae (III-1-1) to (III-1-4):

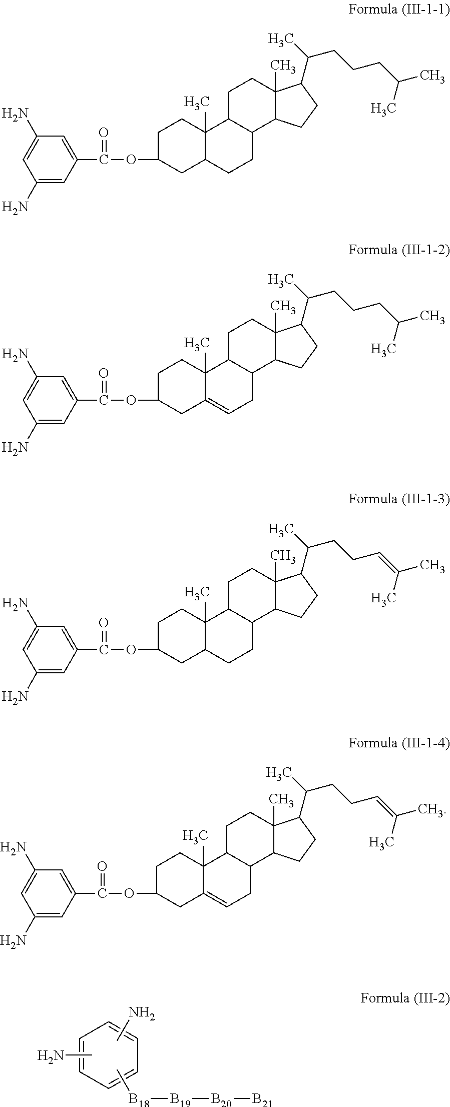

In Formula (III-2), B₁₈ represents

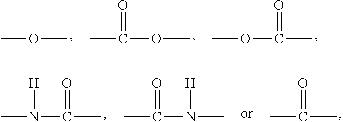

B₁₉ and B₂₀ represents an alicyclic group, an aromatic group or a heterocyclic group; B₂₁ is a C₃-C₁₈ alkyl group, a C₃-C₁₈ alkoxyl group, a C₁-C₅ fluoroalkyl group, a C₁-C₅ fluoroalkoxyl group, a cyano group or a halogen atom.

Preferably, the other diamine compound (b-3) represented by Formula (III-2) is the diamine compound represented by Formulae (III-2-1) to (III-2-13):

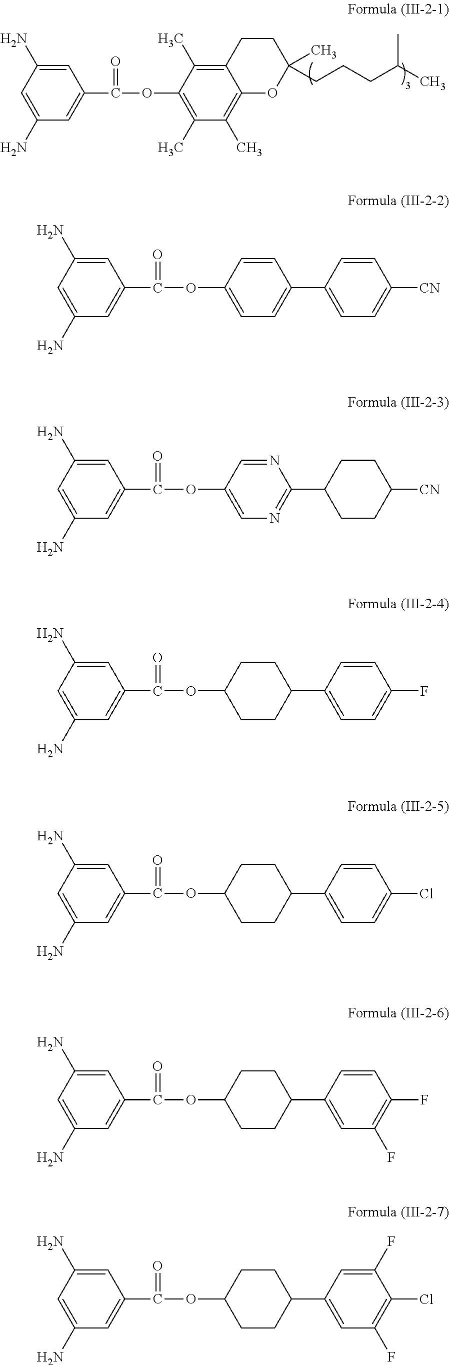

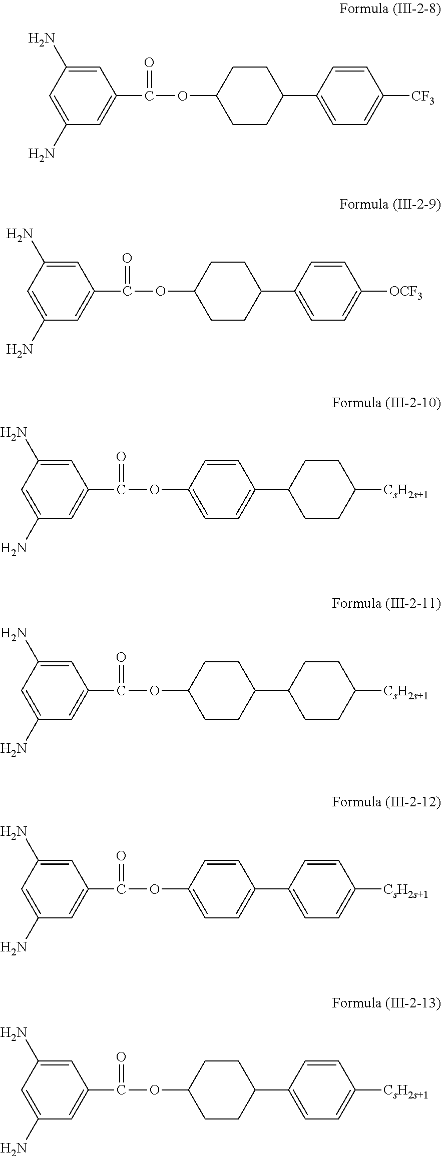

In Formula (III-2-10) to (III-2-13), s represents an integer from 3 to 12.

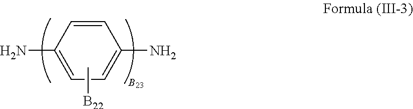

In Formula (III-3), B₂₂ represents a hydrogen atom, a C₁-C₅ acyl group, a C₁-C₅ alkyl group, a C₁-C₅ alkoxy group or a halogen atom. In every repeating unit, B₂₂ can be the same or different; B₂₃ represents an integer from 1 to 3.

Preferably, the other diamine compound (b-3) represented by Formula (III-3) is selected from (1) B₂₃ represents 1: such as p-diaminobenzene, m-diaminobenzene, o-diaminobenzene, 2,5-diaminotoluene or the like; (2) B₂₃ represents 2: such as 4,4′-diaminobiphenyl, 2,2′-dimethyl-4,4′-diaminobiphenyl, 3,3′-dimethyl-4,4′-diaminobiphenyl, 3,3′-dimethoxy-4,4′-diaminobiphenyl, 2,2′-dichloro-4,4′-diaminobiphenyl, 3,3′-dichloro-4,4′-diaminobiphenyl, 2,2′,5,5′-tetrachloro-4,4′-diaminobiphenyl, 2,2′-dichloro-4,4′-diamino-5,5′-dimethoxybiphenyl, 4,4′-diamino-2,2′-bis(trichloromethyl)biphenyl or the like; (3) B₂₃ represents 3: such as 1,4-bis(4′-aminophenyl)benzene and the like, and more preferably is p-diaminobenzene, 2,5-diaminotoluene, 4,4′-diaminobiphenyl, 3,3′-dimethoxy-4,4′-diaminobiphenyl or 1,4-bis(4′-aminophenyl)benzene.

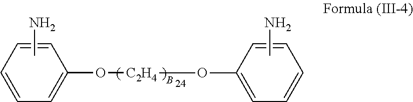

In Formula (III-4), B₂₄ represents an integer from 2 to 12.

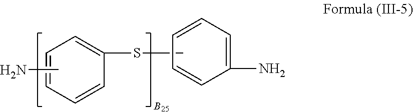

In Formula (III-5), B₂₅ represents an integer from 1 to 5. Preferably, Formula (III-5) is selected from 4,4′-diamino-diphenylsulfide.

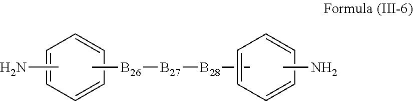

In Formula (III-6), B₂₆ and B₂₈ can be the same or different and respectively represents divalent group; B₂₇ represents a divalent nitrogen-containing cyclic group derived from pyridine, pyrimidine, triazine, piperidine, to piperazine or the like.

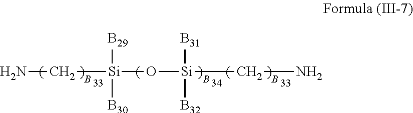

In Formula (III-7), B₂₉, B₃₀, B₃₁ and B₃₂ can be the same or different and respectively represent a C₁-C₁₂ hydrocarbyl group. B₃₃ represents an integer from 1 to 3 and B₃₄ represents an integer from 1 to 20.

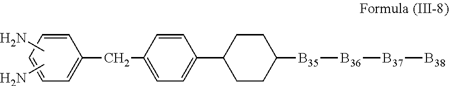

In the Formula (III-8), B₃₅ is —O— or a cyclohexylene; B₃₆ is —CH₂—; B₃₇ is phenylene or cyclohexylene; B₃₈ is a hydrogen atom or a heptyl group.

Preferably, the diamine compound represented by Formula (III-8) is selected from the diamine compound represented by Formulae (III-8-1) to (III-8-2):

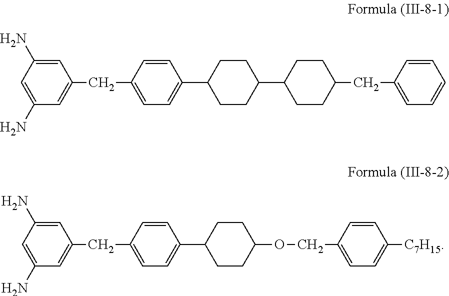

The other diamine compound (b-3) is represented by Formulae (III-9) to (III-25):

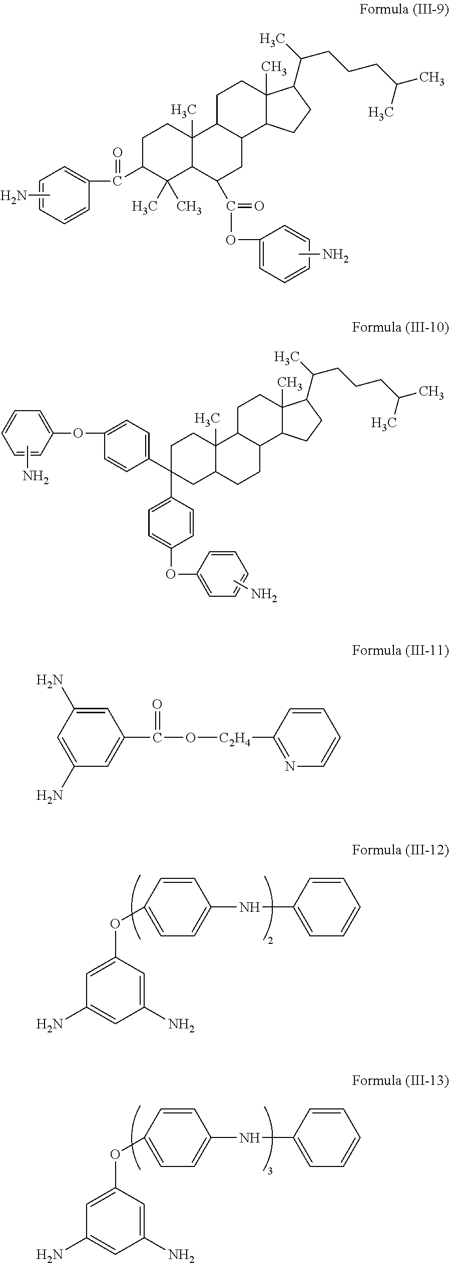

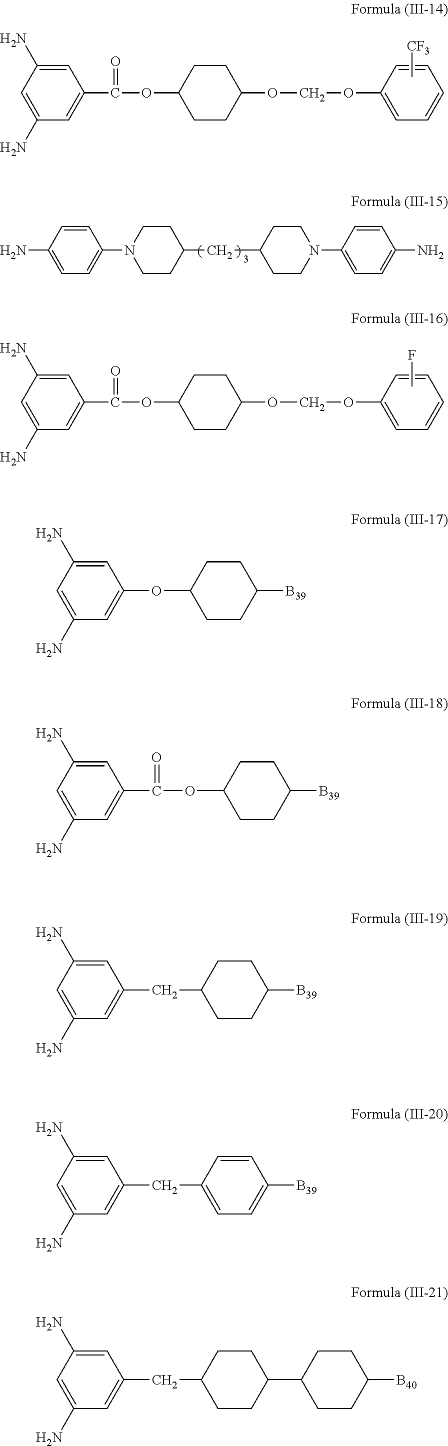

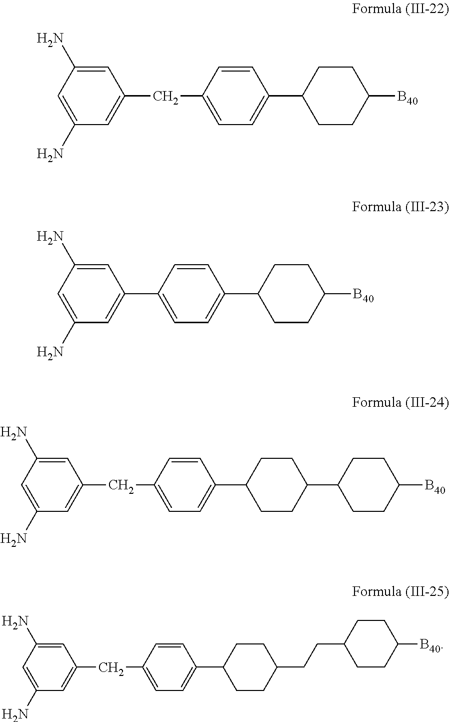

In the Formula (III-17) to (III-25), B₃₉ preferably is a C₁-C₁₀ alkyl group or a C₁-C₁₀ alkoxyl group; B₄₀ preferably is a hydrogen atom, a C₁-C₁₀ alkyl group or a C₁-C₁₀ alkoxyl group.

Preferably, the other diamine compound (b-3) includes but is not limited to 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6.2.1.0^{2,7})-undecenoyl dimethyldiamine, 4,4′-methylenebis(cyclohexylamine), 1,2-diaminoethane, 4,4′-diaminodiphenylmethane, 4,4′-diaminodiphenylether, 5-[4-(4-n-pentylcyclohexyl)cyclohexyl]phenylmethylene-1,3-diaminobenzene, 1,1-bis[4-(4-aminophenoxy)phenyl]-4-(4-ethylphenyl)cyclohexane, 2,4-diaminophenyl ethyl formate, Formula (III-1-1), (III-1-2), (III-2-1), (III-2-11), p-diaminobenzene, m-diaminobenzene, o-diaminobenzene, or the compound represented by Formula (III-8-1); more preferably the other diamine compound (b-3) comprises a cycloaliphatic diamine compound which includes but is not limited to 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadiene diamine, tricyclo(6.2.1.0^{2,7})-undecenoyl dimethyldiamine, 4,4′-methylenebis(cyclohexylamine).

In the present invention, if the other diamine compound (b-3) comprises a cycloaliphatic diamine compound, the liquid crystal alignment agent has good low moisture absorption.

Based on 100 moles of the used amount of the diamine component (b), the used amount of the other diamine compound (b-3) is from 35 to 89 moles; preferably is from 48 to 88 moles; more preferably is from 55 to 82 moles.

The preparation of the polyamic acid polymer according to the invention is dissolving a mixture in a solvent, wherein the mixture comprises a tetracarboxylic dianhydride component (a) and a diamine component (b). A polycondensation reaction is performed at 0° C. to 100° C. After 1 hour to 24 hours, the aforementioned reacting solution is subjected to reduced pressure distillation by an evaporator, or the aforementioned reacting solution is poured into a great quantity of poor solvent to obtain a precipitate. Then, the precipitate is dried by a method of reduced pressure drying to obtain the polyamic acid polymer.

Based on 100 moles of the used amount of the diamine component (b), the used amount of the tetracarboxylic dianhydride component (a) preferably is 20 to 200 moles, and more preferably is 30 to 120 moles.

A solvent used in the polycondensation reaction can be the same as or different from the solvent in the liquid crystal alignment agent. The solvent used in the polycondensation reaction does not have any special limitations. The solvent needs to dissolve the reactant and the product. Preferably, the solvent includes but is not limited (1) aprotic solvent, such as N-methyl-2-pyrrolidinone (NMP), N,N-dimethylacetamide, N,N-dimethyl-formamide, dimethylsulfoxide, γ-butyrolactone, tetramethylurea, hexmethyl phosphoric acid triamino or the like; (2) phenolic solvent, such as m-cresol, xylenol, phenol, halogenated phenol or the like. Based on 100 parts by weight of the mixture, the used amount of the solvent in the polycondensation reaction preferably is 200 to 2000 parts by weight, and more preferably is 300 to 1800 parts by weight.

Particularly, in the polycondensation reaction, the solvent can be combined with a suitable poor solvent, and the polyamic acid polymer is not precipitated in the poor solvent. The poor solvent can be used alone or in combination of two or more, and the poor solvent may include but not limited to (1) alcohols, such as methanol, ethanol, isopropanol, cyclohexanol, ethylene glycol, propylene glycol, 1,4-butanediol, triethyleneglycol or the like; (2) ketone, such as acetone, methyl ethyl ketone, methyl isobutyl ketone, cyclohexanone or the like; (3) ester, such as methyl acetate, ethyl acetate, butyl acetate, diethyl oxalate, diethyl malonate, ethylene glycol monoethyl ether acetate or the like; (4) ether, such as diethyl ether, ethylene glycol methyl ether, ethylene glycol ethyl ether, ethylene glycol n-propyl ether, ethylene glycol isopropyl ether, ethylene glycol n-butyl ether, ethylene glycol dimethyl ether, diethylene glycol dimethyl ether or the like; (5) halohydrocarbon, such as dichloromethane, 1,2-dichloroethane, 1,4-dichlorobutane, trichloroethane, chlorobenzene, m-dichlorobenzene or the like; (6) hydrocarbon, such as tetrahydrofuran, hexane, heptane, octane, benzene, toluene, xylene or the like, or a combination thereof. Based on 100 moles of the used amount of the diamine component (b), the used amount of the poor solvent preferably is 0 to 60 parts by weight, and more preferably is 0 to 50 parts by weight.

The preparation of the polyimide polymer is dissolving a mixture in a solvent, and carrying out a polymerization reaction to form a polyamic acid polymer. The aforementioned mixture comprises the tetracarboxylic dianhydride component (a) and the diamine component (b). Then, heating the polyamic acid to carry out a ring-closing dehydration reaction in the presence of a dehydrating agent and a catalyst and to convert the amic acid group of the polyamic acid to an imide group in the ring-closing dehydration reaction (defined as imidization), so as to form the polyimide polymer.

A solvent used in the ring-closing dehydration reaction can be the same as the solvent in the liquid crystal alignment agent and is not illustrated herein. Based on 100 parts by weight of the used amount of the polyamic acid polymer, the used amount of the solvent in the ring-closing dehydration reaction preferably is 200 to 2000 parts by weight, and more preferably is 300 to 1800 parts by weight.

For getting a better imidization ratio of the polyamic acid polymer, the operating temperature of the ring-closing dehydration reaction preferably is 40° C. to 200° C. More preferably, the aforementioned temperature is 40° C. to 150° C. When the operating temperature of the ring-closing dehydration reaction is lower than 40° C., the reaction is incomplete, thereby lowering the imidization ratio of the polyamic acid polymer. However, when the operating temperature is higher than 200° C., the weight-average molecular weight of the polyimide polymer is lower.

The imidization ratio of the polymer composition (A) is 30% to 90%, preferably is 35% to 88%, and more preferably is 40% to 80%. When the imidization ratio of the polymer composition (A) ranges from 30% to 90%, the liquid crystal alignment agent has good low moisture absorption.

The dehydrating agent used in the ring-closing dehydration reaction is selected from the group consisting of acid anhydride compounds. For example, the acid anhydride compounds are acetic anhydride, propionic anhydride, trifluoroacetic anhydride or the like. Based on 1 mole of the used amount of the polyamic acid, the amount of the dehydrating agent is 0.01 moles to 20 moles. The catalyst used in the ring-closing dehydration reaction is selected from (1) pyridine compound, such as pyridine, trimethyl pyridine, dimethyl pyridine or the like; (2) tertiary amine compound, such as triethyl amine or the like. Based on 1 mole of the used amount of the dehydrating agent, the amount of the catalyst is 0.5 moles to 10 moles.

The polyimide block-copolymer is selected from a polyamic acid block-copolymer, polyimide block-copolymer, polyamic acid-polyimide block copolymer or a combination thereof.

Preferably, a starting material is firstly dissolved in a solvent, and a polycondensation reaction is performed to produce the polyimide block-copolymer. The starting material comprises at least one aforementioned polyamic acid polymer and/or at least one aforementioned polyimide polymer, and the starting material further comprises a tetracarboxylic dianhydride component (a) and diamine component (b).

The tetracarboxylic dianhydride component (a) and the diamine component (b) in the starting material are the same as the tetracarboxylic dianhydride component (a) and the diamine component (b) used in the method of producing aforementioned polyamic acid polymer. A solvent used in the polycondensation reaction is the same as the solvent in the liquid crystal alignment agent and is not illustrated herein.

Based on 100 parts by weight of the used amount of the starting material, the used amount of the solvent in the polymerization reaction preferably is 200 to 2000 parts by weight, and more preferably is 300 to 1800 parts by weight. The operating temperature of the polymerization reaction preferably is 0° C. to 200° C., and more preferably is 0° C. to 100° C.

Preferably, the starting material includes but is not limited to (1) two polyamic acid polymer having different terminal groups and different structures; (2) two polyimide polymers having different terminal groups and different structures; (3) a polyamic acid polymer and a polyimide polymer that have different terminal groups and different structures; (4) a polyamic acid polymer, a tetracarboxylic dianhydride component and a diamine component, and the structure of at least one of the tetracarboxylic dianhydride component and the diamine component is different from the structures of a tetracarboxylic dianhydride component and a diamine component that are used to form the polyamic acid polymer; (5) a polyimide polymer, a tetracarboxylic dianhydride component and a diamine component, and the structure of at least one of the tetracarboxylic dianhydride component and the diamine component is different from the structures of a tetracarboxylic dianhydride component and a diamine component that are used to form the polyimide polymer; (6) a polyamic acid polymer, a polyimide polymer, a tetracarboxylic dianhydride component and a diamine component, and the structure of at least one of the tetracarboxylic dianhydride component and the diamine component is different from the structures of a tetracarboxylic dianhydride component and a diamine component that are used to form the polyamic acid polymer or the polyimide polymer; (7) two polyamic acid polymers, two tetracarboxylic dianhydride components or two diamine components, and they have different structures; (8) two polyimide polymers, two tetracarboxylic dianhydride components or two diamine components, and they have different structures; (9) two polyamic acid polymers and a diamine component, and the two polyamic acid polymers have different structures and the terminal groups of the polyamic acid polymers are acetic anhydride groups; (10) two polyamic acid polymers and a tetracarboxylic dianhydride component, and the two polyamic acid polymers have different structures and the terminal groups of the polyamic acid polymers are amine groups; (11) two polyimide polymers and a diamine component, and the two polyimide polymers have different structures and the terminal groups of the polyimide are acid anhydride groups; (12) two polyimide polymers and a tetracarboxylic dianhydride component, and the two polyimide polymers have different structures and the terminal groups of the polyimide are amine groups.

Preferably, the polyamic acid polymer, the polyimide polymer and the polyimide block copolymer can be terminal-modified polymers after adjusting the molecular weights without departing from the efficiency of the present invention. The terminal-modified polymers can improve coating ability of the liquid crystal alignment agent. The manner for producing the terminal-modified polymers can be adding a compound having a monofunctional group when synthesizing the polyamic acid in a polycondensation reaction. The monofunctional group includes but is not limited to (1) monoacid anhydride, such as maleic anhydride, phthalic anhydride, itaconic anhydride, n-decyl succinic anhydride, n-dodecyl succinic anhydride, n-tetradecyl succinic anhydride, n-hexadecyl succinic anhydride or the like; (2) a monoamine compound, such as aniline, cyclohexaylamine, n-butylamine, n-pentylamine, n-hexylamine, n-heptylamine, n-octylamine, n-nonylamine, n-decylamine, n-undecylamine, n-dodecylamine, n-tridecylamine, n-tetradecylamine, n-pentadecylmaine, n-hexadecylamine, n-heptadecylamine, n-octadecylamine, n-eicosylamine or the like; (3) a monoisocyanate compound, such as phenyl isocyanate, naphthyl isocyanate or the like.

Preferably, the solvent (B) suitable in the present invention is N-methyl-2-pyrrolidone (NMP), γ-butyrolactone, γ-butyrolactam, 4-hydroxyl-4-methyl-2-pentanone, ethylene glycol monomethyl ether, butyl lactate, butyl acetate, methylmethoxypropionate, ethylethoxypropionate, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diglycol dimethyl ether, diglycol diethyl ether, diglycol monomethyl ether, diglycol monoethyl ether, diglycol monomethyl ether aceatte, diglycol monoethyl ether aceate, N,N-dimethylformamide, N,N-dimethylethanamide or the like. The solvent (B) can be used alone or in combination of two or more.

Without departing from the efficiency of the present invention, the liquid crystal alignment agent according to the invention preferably comprises an additive (C). The additive (C) is an epoxy compound or a functional group-containing silane compound. The additive (C) can raise the adhesion between the liquid crystal alignment film and a surface of a substrate. The additive (C) can be used alone or in combination of two or more.

The epoxy compound includes but is not limited to ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, 2,2-dibromo-neopentyl diglycidyl ether, 1,3,5,6-tetraglycidyl-2,4-hexanediol, N,N,N′,N′-tetraglycidyl-m-xylene diamine, 1,3-bis(N,N-diglycidylaminomethyl)cyclohexane, N,N,N′,N′-tetraglycidyl-4,4′-diaminodiphenylmethane, N,N-diglycidyl-p-glycidoxy aniline, 3-(N-allyl-N-glycidyl)aminopropyltrimethoxyl silane, 3-(N,N-diglycidyl)aminopropyl trimethoxyl silane or the like.

Based on 100 parts by weight of the used amount of the polymer composition (A), the used amount of the epoxy compound is less than 40 parts by weight, and preferably is 0.1 parts by weight to 30 parts by weight.

The functional group-containing silane compound includes but is not limited to 3-aminopropyl trimethoxy silane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyl dimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyl triethoxysilane, N-bis(oxyethylene)-3-aminopropyltrimethoxysilane, N-bis(oxyethylene)-3-aminopropyltriethoxysilane or the like.

Based on 100 parts by weight of the used amount of the polymer composition (A), the amount of the silane-containing compound is less than 10 parts by weight, and preferably is 0.5 parts by weight to 10 parts by weight.

The preparation of the liquid crystal alignment agent is not limited, and can be a common mixture method. For example, the tetracarboxylic dianhydride component (a) and the diamine component (b) are mixed uniformly to produce the polymer composition (A). Then, the polymer composition (A) is added to the solvent (B) at 0° C. to 200° C. in a mixer and the additive (C) is selectively added until all compositions are mixed uniformly. Preferably, the solvent (B) is added into the polymer composition (A) at 20° C. to 60° C.

Preferably, at 25° C., the viscosity of the liquid crystal alignment agent is 15 cps to 35 cps, preferably is 17 cps to 33 cps, and more preferably is 20 cps to 30 cps.

The method for forming the liquid crystal alignment film comprises the following steps. The aforementioned liquid crystal alignment agent firstly is coated on a surface of a substrate to form a coating film by a roller coating, a spin coating, a printing coating, an ink-jet printing or the like. Then, a pre-bake treatment, a post-bake treatment and an alignment treatment are subjected to the coating film to obtain the liquid crystal alignment film.

The pre-bake treatment is for volatilizing the organic solvent in the coating film. Preferably, the pre-bake treatment is conducted at 30° C. to 120° C.; more preferably at 40° C. to 110° C.; still more preferably at 50° C. to 100° C.

The alignment treatment is not limited, and can be conducted by rubbing in a certain direction for alignment with a roller wound with a cloth made by nylon, rayon, cotton or other fibers.

The post-bake treatment is for a further ring-closing dehydration reaction (imidization) of the polymers in the coating film. Preferably, the post-back treatment is conducted at 150° C. to 300° C., more preferably at 180° C. to 280° C., still more preferably at 200° C. to 250° C.

The method for producing the liquid crystal display element is known to artisans skilled in this field and only briefed as below.

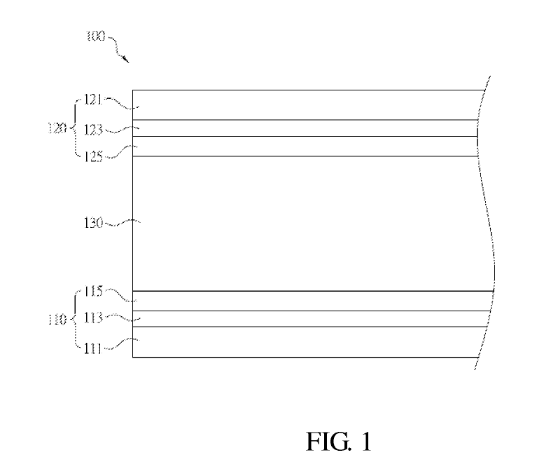

FIG. 1 is a lateral-view diagram of the liquid crystal display element according to the present invention. In one preferred embodiment, a liquid crystal display element 100 comprises a first unit 110, a second unit 120 and a liquid crystal unit 130. The second unit 120 is set opposite to the first unit 110 with an interval, and the liquid crystal unit 13 is set between the first unit 110 and the second unit 120.

The first unit 110 comprises a first substrate 111, a first conductive film 113 and a first liquid crystal alignment film 115. The first conductive film 113 is formed on the first substrate 111, and the first liquid crystal alignment film 115 is formed on a surface of the first conductive film 113.

The second unit 120 comprises a second substrate 121, a second conductive film 123 and a second liquid crystal alignment film 125. The second conductive film 123 is formed on the second substrate 121, and the second liquid crystal alignment film 125 is formed on a surface of the second conductive film 123.

The first substrate 111 and the second substrate 121 is a transparent material. The transparent material comprises but is not limited to alkali-free glass, soda-lime glass, hard glass (Pyrex glass), and quartz glass, polyethylene terephthalate, polybutylene terephthalate, polyether sulfone, or polycarbonate for liquid crystal display device. The material of the first conductive film 113 and the second conductive film 123 is selected from SnO₂, In₂O₃-SnO₂, or the like.

The first liquid crystal alignment film 115 and the second liquid crystal alignment film 125 are the above mentioned liquid crystal alignment film, respectively, and are for forming a pretilt angle of the liquid crystal unit 130. The liquid crystal unit 130 can be driven by the electric field formed by the first conductive film 113 and the second conductive film 123.

The liquid crystal used in the liquid crystal unit 130 can be used alone or in combinations. The liquid crystal comprises but is not limited to diaminobenzene liquid crystal, pyridazine liquid crystal, shiff base liquid crystal, azoxy liquid crystal, biphenyl liquid crystal, phenyl cyclohexane liquid crystal, liquid crystal, terphenyl liquid crystal, biphenylcyclohexane liquid crystal, pyrimidine liquid crystal, dioxane liquid crystal, bicyclooctane liquid crystal, or cubane liquid crystal, and optionally adding steroid liquid crystal such as cholesteryl chloride, cholesteryl nonanoate, or cholesteryl carbonate), or chiral agent such as C-15, CB-15 (manufactured by Merck), or ferroelectric liquid crystal such as p-decyloxybenzylidene-p-amino-2-methylbutyl cinnamate.

The following examples are given for the purpose of illustration only and are not intended to limit the scope of the present invention.

<Preparation of the Diamine Compound (b-1)>

### PREPARATION EXAMPLE b-1-1

b-1-1 is represented by Formula (I-10), wherein the preparation method is shown as the following Scheme 1:

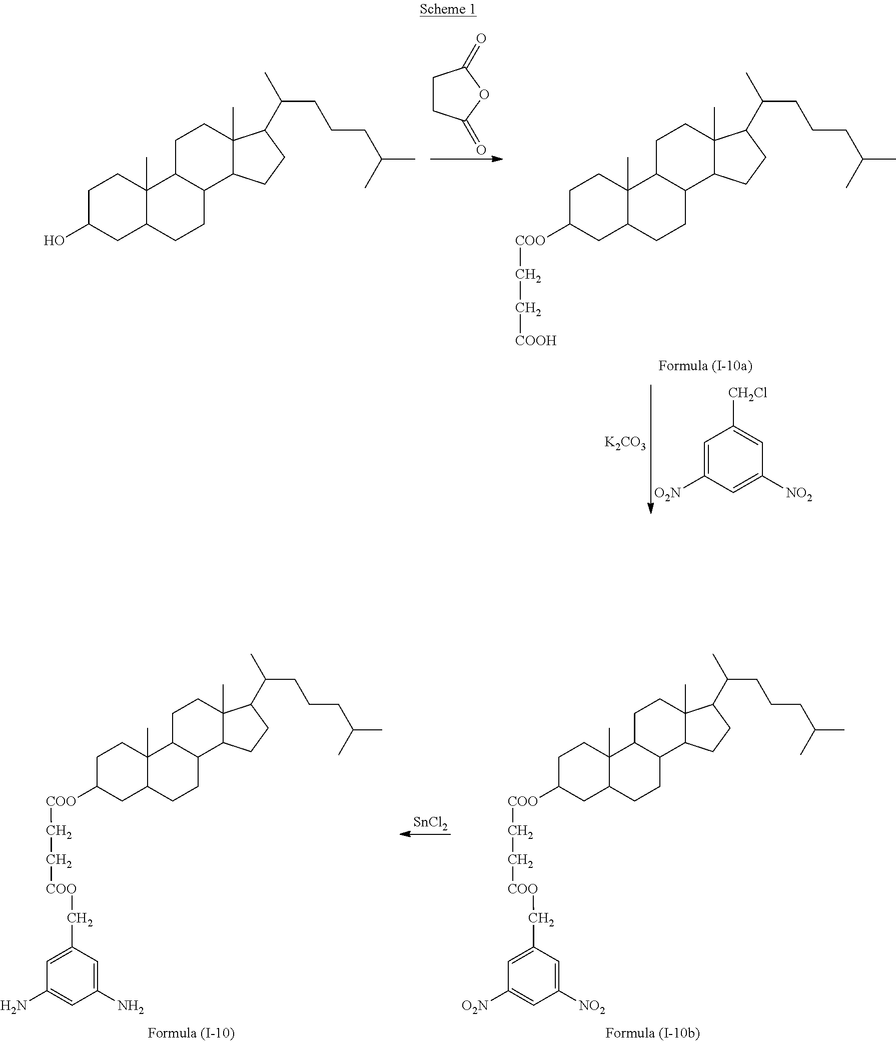

### The Preparation of Formula (I-10a):

A 5 L three-necked flask was set with a stirrer, nitrogen inlet and thermometer. 389 g of β-cholestanol, 201 g of succinic anhydride, 15 g of N,N-dimethylamino pyridine, 170 g of triethylamine and 2 L of ethyl acetate were added and reacted at 90° C. for 8 hours. After completing the reaction, ethyl acetate was removed by vacuum distillation, and 2 L of chloroform was added. After an organic layer was washed by dilute hydrochloric acid three times and by water four times, the organic layer was dried by magnesium sulfate. Then, the organic layer was concentrated by filtrating for removing precipitation and solvent to obtain 223 g of the white powder of compound represented by Formula (I-10a).

Formula (I-10a) can be prepared repeatedly to obtain the amount of the following preparation required.

### The Preparation of Formula (I-10b):

A 5 L three-necked flask was set with a stirrer, nitrogen inlet and thermometer. 223 g of the aforementioned compound represented by Formula (I-10a), 108 g of 3,5-dinitrobenzyl chloride, 207 g of potassium carbonate, 150g of sodium iodide and 1500 mL of N,N-dimethyl formamide were added and reacted at 60° C. for 8 hours. After completing the reaction, 3 L of chloroform was added. After an organic layer was washed by water three times, then the organic layer was dried by magnesium sulfate. The organic layer was concentrated. Then precipitation solid was recycled and washed by ethanol to obtain 280 g of light yellow powder of the compound represented by Formula (I-10b).

### The Preparation of Formula (I-10):

A 5 L three-necked flask was set with a stirrer, nitrogen inlet and thermometer. 200 g of the aforementioned compound represented by Formula (I-10b), 680 g of SnCl₂.2H₂O and 2 L of ethyl acetate were added and refluxed for 4 hours. After completing the reaction, the mixture was washed by aqueous potassium fluoride and water sequentially. An organic layer was dried by magnesium sulfate and concentrated and then recrystallized by ethanol to obtain 58 g of light yellow powder of the compound represented by Formula (I-10).

### PREPARATION EXAMPLE b-1-2

b-1-2 is represented by Formula (I-18), wherein the preparation method is shown as the following Scheme 2:

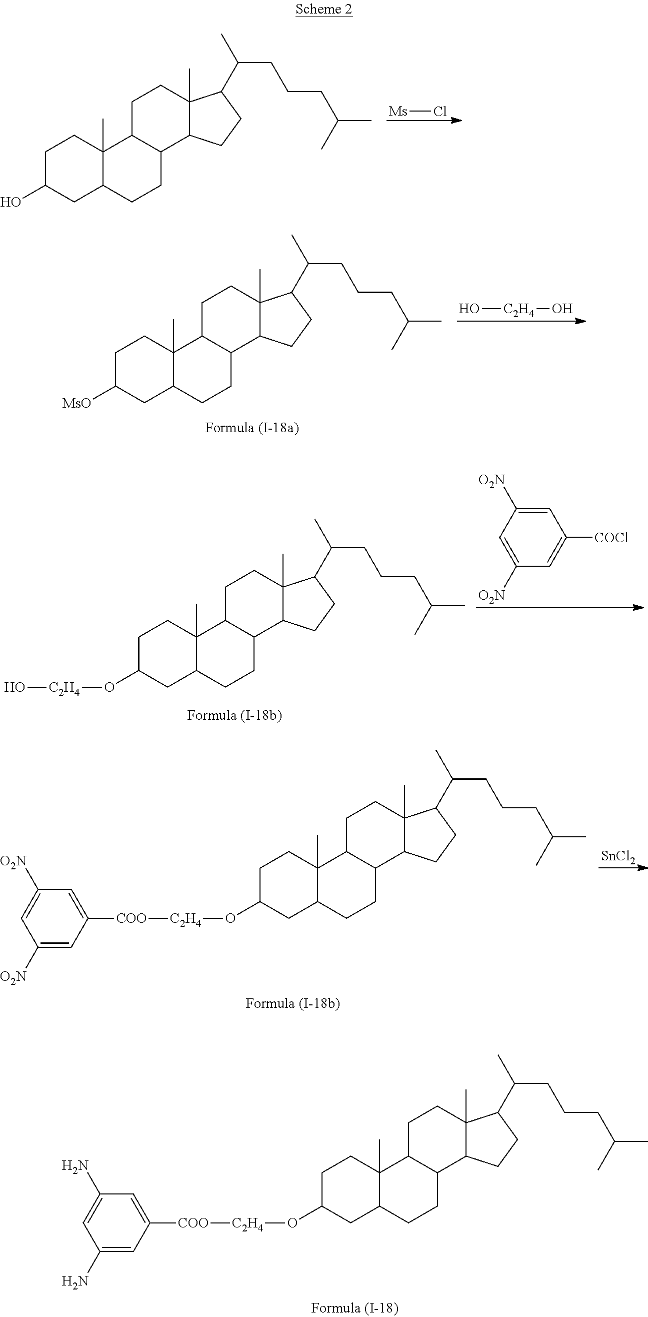

### The Preparation of Formula (I-18a):

A 1 L three-necked flask was set with a dropping funnel, thermometer and nitrogen inlet. 117 g of β-cholestanol, 3.7 g of N,N-dimethylamino pyridine, 400 mL of tetrahydrofuran and 55 mL of triethylamine were added and reacted in ice bath. Mixed solution of 100 mL methane sulfonyl chloride (MsCl) and tetrahydrofuran was purged in the dropping funnel and dropped in reaction solution within 1 hour, and then reacted at the room temperature for 3 hours. After completing the reaction, 500 mL of ethyl acetate was added in the mixture to obtain an organic layer. Then, the organic layer was washed by water three times and dried by magnesium sulfate. 300 mL of organic layer was concentrated and dispersed in 600 mL of ethanol to obtain white precipitation, then dried to obtain 117 g of the compound represented by Formula (I-18a). In Formula (I-18a), Ms represents methylsulfonyl (CH₃SO₂—).

### The Preparation of Formula (I-18b):

46.7 g of the aforementioned compound represented by Formula

(I-18a), 155 g of ethylene glycol and 200 mL of 1,4-dioxane were mixed, then heated and stirred at 100° C. for 20 hours. After completing the reaction, 500 mL of water and 500 mL of chloroform were added in the mixture and stirred to separate an organic layer. Then the organic layer was washed by 500 mL of sodium bicarbonate saturated aqueous solution one time and 500 mL of water two times. The organic layer was dried by magnesium sulfate. After filtrated and concentrated, 500 mL of ethanol was added and stirred at 0° C. overnight. Then after filtrated to obtain white precipitate, the filtrated liquid was concentrated and solvent was removed, and 26.6 g of viscous liquid of the compound represented by Formula (I-18b) was obtained.

### The Preparation of Formula (I-18c):

26.3 g of the aforementioned compound represented by Formula (I-18b) and 14 g of 3,5-dinitrobenzoyl acyl chlorine were mixed in 300 mL of THF solvent and stirred in 0° C. for 10 hours. Then, 8.4 mL of triethylamine was dropped slowly in 10 minute and stirred at the room temperature for 3 hours. After completing the reaction, the mixture was concentrated and added with 500 mL of chloroform, and then washed by 300 mL of water four times. An organic layer was dried by magnesium sulfate. After filtrated and concentrated, viscous liquid was recycled. The viscous liquid was purified by column chromatography, and chloroform was used as solvent front to obtain 20 g of the light yellow oily compound represented by Formula (I-18c).

### The Preparation of Formula (I-18):

20 g of the aforementioned compound represented by Formula (I-18c) and 78 g Tin chloride dihydrate (II) were mixed in 350 mL of ethyl acetate solvent under nitrogen gas, and then refluxed, heated and stirred for 4 hours. Then, 400 mL of 2 mol/L of potassium fluoride was added and stirred, and the salt was filtrated. An organic layer was washed by 400 mL of 2 mol/L potassium fluoride one time and 400 mL of water three times. The organic layer was dried by magnesium sulfate, and then filtrated and concentrated to obtain light yellow powder. The powder was purified by column chromatography and chloroform/ethanol=95/5 (volume ratio) was used as developing solvent to obtain 14 g of white powder of the compound represented by Formula (I-18). Preparation Example b-1-3:

b-1-3 is represented by Formula (I-24), wherein the preparation method is shown as the following Scheme 3:

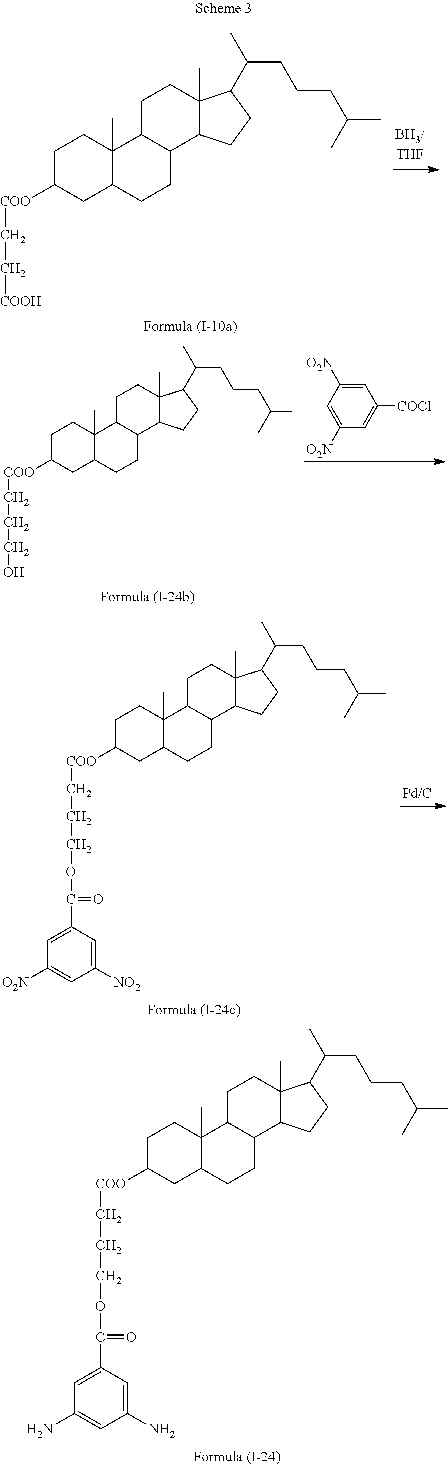

### The Preparation of Formula (I-24b):

A 0.5 L three-necked flask was set with a dropping funnel, nitrogen inlet and thermometer. 24 g of the aforementioned compound represented by Formula (I-10a) and 150 mL of tetrahydrofuran were mixed, and cooled to 18° C. 55 mL of 0.9 mol/L of borane-tetrahydrofuran complex compound/tetrahydrofuran was purged in the dropping funnel, and dropped in reaction solution in 30 minutes and reacted at the room temperature for 16 hours. After completing the reaction, the mixture was maintained in ice bath. 30 mL of water and ethyl acetate was slowly added. An organic layer was washed by sodium bicarbonate saturated aqueous solution two times and water three times. The organic layer was dried by magnesium sulfate, then concentrated and filtrated to obtain 17 g of white powder of the compound represented by Formula (I-24b).

### The Preparation of Formula (I-24c):

A 0.5 L three-necked flask was set with a dropping funnel, nitrogen inlet and thermometer. 15 g of the aforementioned compound represented by Formula (I-24b), 4.5 mL of triethylamine and 100 mL of tetrahydrofuran were mixed and cooled in ice bath. 50 mL of 7.4 g of 3,5-dinitrobenzoyl chloride dissolved in tetrahydrofuran of was purged in the dropping funnel, dropped in reaction solution in 1 hour and reacted at the room temperature for 2 hours. After completing the reaction, the mixture was added with ethyl acetate. An organic layer was washed by sodium bicarbonate saturated aqueous solution two times and water three times. The organic layer was dried by magnesium sulfate, then concentrated, filtrated and then recrystallized by ethanol to obtain 10 g of the compound represented by Formula (I-24c).

### The Preparation of Formula (I-24):

A 1 L three-necked flask was set with a reflux tube, nitrogen inlet and thermometer. 10 g of the aforementioned compound represented by Formula (I-24c), 5 weight % of Pd/C powder 95 mg, 120 mL of ethanol, 60 mL of tetrahydrofuran and 3.8 mL of Xin of hydrazine hydrate were stirred at the room temperature for 1 hour and at 70° C. for 1 hour. After completing the reaction, the mixture was filtrated by diatomaceous earth to obtain 300 mL of filtrated solution. The filtrated solution was added with ethyl acetate to obtain an organic layer. The organic layer was washed by water three times. After concentrated and filtrated, the dried was recrystallized by ethanol to obtain 7 g of the compound represented by Formula (I-24).

### PREPARATION EXAMPLE b-1-4

b-1-4 is represented by Formula (I-22), wherein the preparation method is shown as the following Scheme 4:

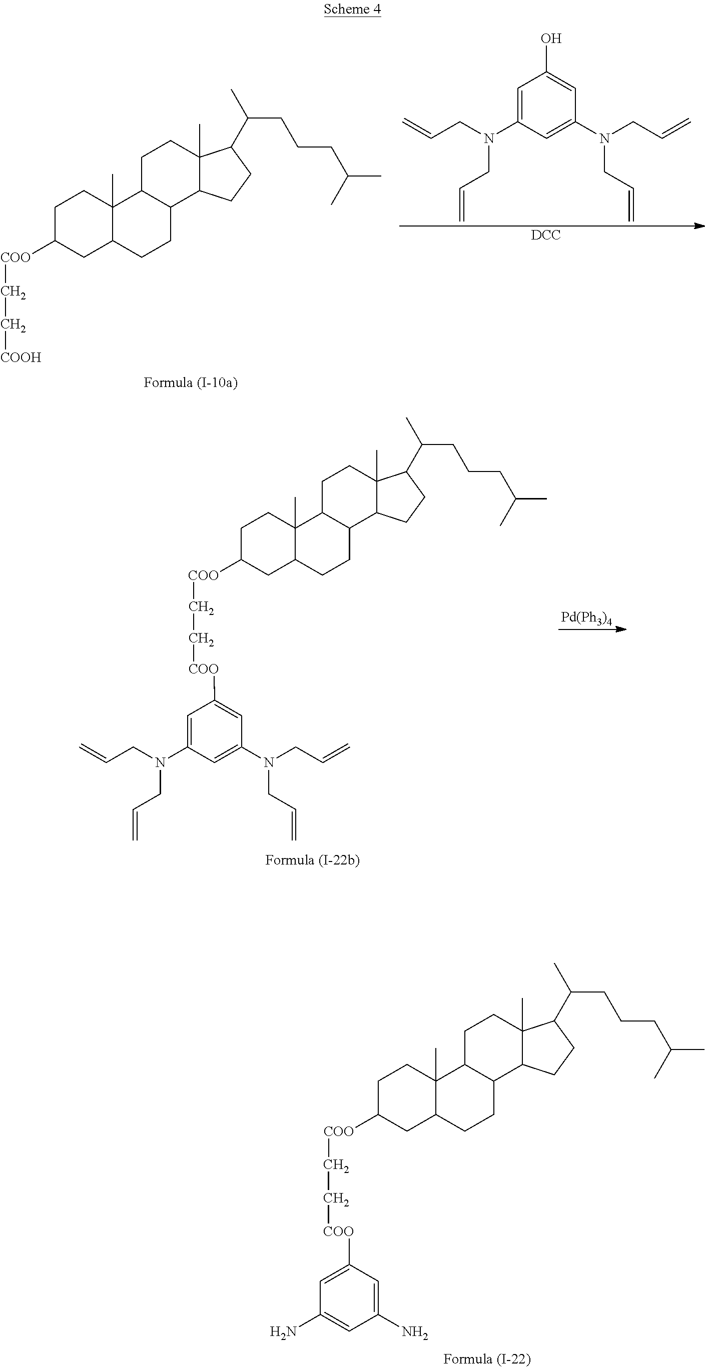

### The Preparation of Formula (I-22b):

47 g of the aforementioned compound represented by Formula (I-10a), 28 g of 3,5-(N,N-diallyl)di-aminophenol and 400 mL of tetrahydrofuran were mixed and stirred at 0° C. 25 g of N,N-dicyclohexylcarbodiimide (DCC) and 2.4 g of N,N-dimethylamino pyridine were added and stirred at 25° C. for 4 hours. After added chloroform, an organic layer was washed and then concentrated. The concentrated was purified by column chromatography, and hexane:ethyl acetate=8:1 (volume ratio) was used as developing solvent to obtain the compound represented by Formula (I-22b).

### The Preparation of Formula (I-22b):

38 g of the aforementioned compound represented by Formula (I-22b), 23 g of dimethyl barbituric acid and 1.1 g of tetrakis(triphenylphosphine)palladium(0), Pd(Ph₃)₄ were mixed in 200 mL of dichloromethane and stirred at 35° C. for 7 hours. After completing the reaction, an organic layer was washed by sodium bicarbonate saturated aqueous solution and water sequentially. Then the organic layer was concentrated to obtain brown viscous liquid. The brown viscous liquid was purified by column chromatography, and chloroform:ethanol=95:5 (volume ratio) was used as developing solvent. Then, the brown viscous liquid was recrystallized by ethanol to obtain 13 g of light yellow powder of the compound represented by Formula (I-22).

### PREPARATION EXAMPLE b-1-5

b-1-5 is represented by Formula (I-26), wherein the preparation method is shown as the following Scheme 5:

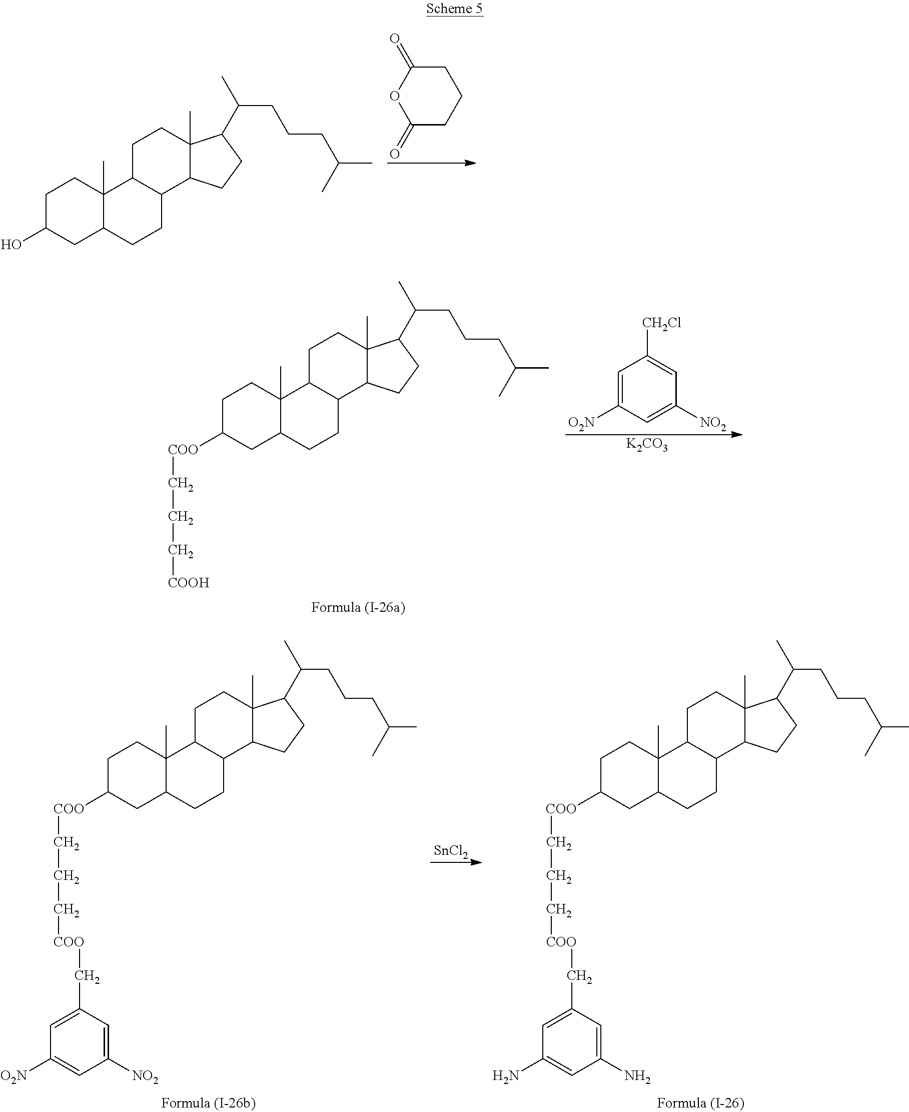

### The Preparation of Formula (I-26a):

A 10 L three-necked flask was set with a stirrer, nitrogen inlet and thermometer. 778 g of β-cholestanol, 458 g of glutaric anhydride, 30 g of N,N-dimethylamino pyridine, 340 mL of triethylamine and 4 L of ethyl acetate were added and reacted at 90° C. for 8 hours. After completing the reaction, ethyl acetate was removed by vacuum distillation, and 2 L of chloroform was added. After an organic layer was washed by dilute hydrochloric acid three times and water four times, the organic layer was dried by magnesium sulfate. Then, the organic layer was concentrated by filtration for removing precipitation and solvent to obtain 498 g white powder of the compound represented by Formula (I-26a).

### The Preparation of Formula (I-26b):

A 5 L three-necked flask was set with a stirrer, nitrogen inlet and thermometer. 254 g of the aforementioned compound represented by Formula (I-26a), 108 g of 3,5-dinitrobenzyl chloride, 207 g of potassium carbonate, 150g of sodium iodide and 1500 mL of N,N-dimethyl formamide were added and reacted at 60° C. for 8 hours. After completing the reaction, 3 L of chloroform was added. After an organic layer was washed by water three times, and then the organic layer was dried by magnesium sulfate. The organic layer was concentrated. Then precipitation solid was recycled and washed by ethanol to obtain 305 g of light yellow powder of the compound represented by Formula (I-26b).

### The Preparation of Formula (I-26):

A 5 L three-necked flask was set with a stirrer, nitrogen inlet and thermometer. 228 g of the aforementioned compound represented by Formula (I-26b), 680 g of SnCl₂.2H₂O and 2 L of ethyl acetate were added and refluxed for 4 hours. After completing the reaction, the mixture was washed by aqueous potassium fluoride and water sequentially. An organic layer was dried by magnesium sulfate and concentrated and then recrystallized by ethanol to obtain 60 g of light yellow powder of the compound represented by Formula (I-26).

### <Preparation of the Polymer Composition (A)>

Synthesis Examples and Comparative Synthesis Examples of the polymer composition (A) are shown in Table 1 and Table 2.

### SYNTHESIS EXAMPLE A-1-1

A 500 mL four-necked flask was set with a nitrogen inlet, stirrer, condenser and thermometer, and nitrogen. 10 moles % of compound represented by Formula (I-10) (b-1-1), 1 mole % of compound represented by Formula (II-10) (b-2-1), 69 mole % of p-diaminobenzene (b-3-1), 20 mole % of 4,4′-methylene bis(cyclohexyl amine) (b-3-5) and 80 g of N-methyl-2-pyrrolidone (hereafter referred as NMP) were stirred to dissolved at the room temperature. Then, 100 moles % of 2,3,5-tricarboxycyclopentylacetic acid dianhydride (a-1) and 20 g NMP was added for reacting at the room temperature for 2 hours. After completing the reaction, the reaction solution was poured into 1500 mL of water to precipitate the polymers. The filtered polymers were washed with methanol and filtered for three times and dried at 60° C. with a vacuum oven to obtain the polyamic acid polymer (A-1-1). The imidization ratio of the resulted polymer composition (A-1-1) was evaluated according to the following evaluation method, and the result thereof is listed as Table 1. The evaluation method of the imidization ratio was described as follows.

### SYNTHESIS EXAMPLE A-1-2 TO A-1-5 AND COMPARATIVE SYNTHESIS EXAMPLE A-3-2

The Synthesis Examples A-1-2 to A-1-5 and Comparative Synthesis Example A-3-2 are similar to Synthesis Example A-1-1 with the modifications of various kinds and amounts of the compositions for the polymer composition. The formulations and evaluation results thereof are listed in Table 1 and Table 2 and are not repeated herein.

### SYNTHESIS EXAMPLE A-2-1

A 500 mL four-necked flask was set with a nitrogen inlet, stirrer, condenser and thermometer, and nitrogen. 10 moles % of compound represented by Formula (I-10) (b-1-1), 1 mole % of compound represented by Formula (II-10) (b-2-1), 69 mole % of p-diaminobenzene (b-3-1), 20 mole % of 4,4′-methylene bis(cyclohexyl amine) (b-3-5) and 80 g of N-methyl-2-pyrrolidone (hereafter referred as NMP) were stirred to dissolved at the room temperature. Then, 100 moles % of 2,3,5-tricarboxycyclopentylacetic acid dianhydride (a-1) and 20 g NMP were added for reacting at the room temperature for 6 hours, and 97 g of NMP, 5.61 g of acetic anhydride and 19.75 g of pyridine were added and heated to 60° C. for imidization for 2 hours. After completing the reaction, the reaction solution was poured into 1500 mL of water to precipitate the polymers. The polymers filtered were washed with methanol and filtered for three times and dried at 60° C. with a vacuum oven to obtain the polyamic acid polymer (A-2-1). The imidization ratio of the resulted polymer composition (A-1-1) is listed in Table 1.

### SYNTHESIS EXAMPLE A-2-2 TO A-2-10 AND COMPARATIVE SYNTHESIS EXAMPLE A-3-1, A-3-3 TO A-3-7

The Synthesis Examples A-2-2 to A-2-10 and Comparative

Synthesis Example A-3-1, A-3-3 to A-3-7 are similar to Synthesis Example A-2-1 with the modifications of various kinds and amounts of the compositions for the polyimide polymer. The formulations and evaluation results thereof are listed in Table 1 and Table 2 and are not repeated herein.

TABLE 1

| | | | Synthesis Examples | | | | | | | |
|---|---|---|---|---|---|---|---|---|---|---|
| Component (mole %) | | | A-1-1 | A-1-2 | A-1-3 | A-1-4 | A-1-5 | A-2-1 | A-2-2 | A-2-3 |
| diamine compound (a) | | a-1 | 100 | | | | 100 | 100 | | |
| | | a-2 | | 100 | | 50 | | | 100 | |
| | | a-3 | | | 100 | 50 | | | | 100 |
| diamine | diamine | b-1-1 | 10 | | | | | 10 | | |
| component | compound | b-1-2 | | 20 | | | | | 20 | |
| (b) | (b-1) | b-1-3 | | | 30 | | | | | 30 |
| | | b-1-4 | | | | 40 | 20 | | | |
| | | b-1-5 | | | | | 30 | | | |
| | diamine | b-2-1 | 1 | | | | | 1 | | |
| | compound | b-2-2 | | | 15 | | 5 | | | 15 |
| | (b-2) | b-2-3 | | 5 | | | 5 | | 5 | |
| | | b-2-4 | | | | 10 | | | | |
| | diamine | b-3-1 | 69 | | 55 | 10 | | 69 | | 55 |
| | compound | b-3-2 | | 60 | | 40 | | | 60 | |
| | (b-3) | b-3-3 | | | | | | | | |
| | | b-3-4 | | | | | | | | |
| | | b-3-5 | 20 | | | | 40 | 20 | | |
| | | b-3-6 | | 15 | | | | | 15 | |

| | | | | | | | | |
|---|---|---|---|---|---|---|---|---|
| molar ratio of (b-1)/(b-2) | 10.00 | 4.00 | 2.00 | 4.00 | 5.00 | 10.00 | 4.00 | 2.00 |
| imidization ratio (%) | 0 | 0 | 0 | 0 | 0 | 12 | 25 | 38 |

| | | | Synthesis Examples | | | | | | |
|---|---|---|---|---|---|---|---|---|---|
| Component (mole %) | | | A-2-4 | A-2-5 | A-2-6 | A-2-7 | A-2-8 | A-2-9 | A-2-10 |
| diamine compound (a) | | a-1 | | 100 | | | 100 | | 50 |
| | | a-2 | 50 | | | 100 | | 100 | |
| | | a-3 | 50 | | 100 | | | | 50 |
| diamine | diamine | b-1-1 | | | | | | 40 | |
| component | compound | b-1-2 | | | 15 | | 15 | | |
| (b) | (b-1) | b-1-3 | | | | 10 | | | 50 |
| | | b-1-4 | 40 | | | | 15 | | |
| | | b-1-5 | | 50 | | | | | |
| | diamine | b-2-1 | | | | | 5 | | |
| | compound | b-2-2 | | 5 | 15 | | | 15 | |
| | (b-2) | b-2-3 | | 5 | | 10 | | | 3 |
| | | b-2-4 | 10 | | | | | | |
| | diamine | b-3-1 | 10 | | | 75 | | 45 | 30 |
| | compound | b-3-2 | 40 | | 40 | | 65 | | |
| | (b-3) | b-3-3 | | | | | | | |
| | | b-3-4 | | | | | | | |
| | | b-3-5 | | 40 | | 5 | | | 17 |
| | | b-3-6 | | | 30 | | | | |

| | | | | | | | |
|---|---|---|---|---|---|---|---|
| molar ratio of (b-1)/(b-2) | 4.00 | 5.00 | 1.00 | 1.00 | 6.00 | 2.67 | 16.67 |
| imidization ratio (%) | 46 | 53 | 62 | 77 | 85 | 92 | 63 |

TABLE 2

| | | | Comparative Synthesis Example | | | | | | |
|---|---|---|---|---|---|---|---|---|---|
| Component (mole %) | | | A-3-1 | A-3-2 | A-3-3 | A-3-4 | A-3-5 | A-3-6 | A-3-7 |
| diamine compound (a) | | a-1 | 100 | | | | | 100 | |
| | | a-2 | | 100 | 100 | 100 | | | 100 |
| | | a-3 | | | | | 100 | | |
| diamine | diamine | b-1-1 | | | | | 10 | | |
| component | compound | b-1-2 | | 40 | | | | | |
| (b) | (b-1) | b-1-3 | | | | | | | |
| | | b-1-4 | | | | | 10 | | |
| | | b-1-5 | | | | | | | |
| | diamine | b-2-1 | | | | | | | |
| | compound | b-2-2 | 5 | | | | | | |
| | (b-2) | b-2-3 | | | | 10 | | | |
| | | b-2-4 | | | | | | | |
| | diamine | b-3-1 | 95 | | 80 | | 70 | | 90 |
| | compound | b-3-2 | | 60 | | 70 | | 80 | |
| | (b-3) | b-3-3 | | | | | | 20 | |
| | | b-3-4 | | | | | | | 30 |
| | | b-3-5 | | | | 20 | | | |
| | | b-3-6 | | | 20 | | 10 | | |

| | | | | | | | |
|---|---|---|---|---|---|---|---|
| molar ratio of (b-1)/(b-2) | 0.00 | — | — | 0.00 | — | — | — |
| imidization ratio (%) | 27 | 0 | 37 | 55 | 43 | 65 | 85 |

### In Table 1 and Table 2:

a-1-1 2,3,5-tricarboxycyclopentyl acetic dianhydride
a-1-2 1,2,3,4-cyclobutane tetracarboxylic dianhydride
a-1-3 pyromellitic dianhydride

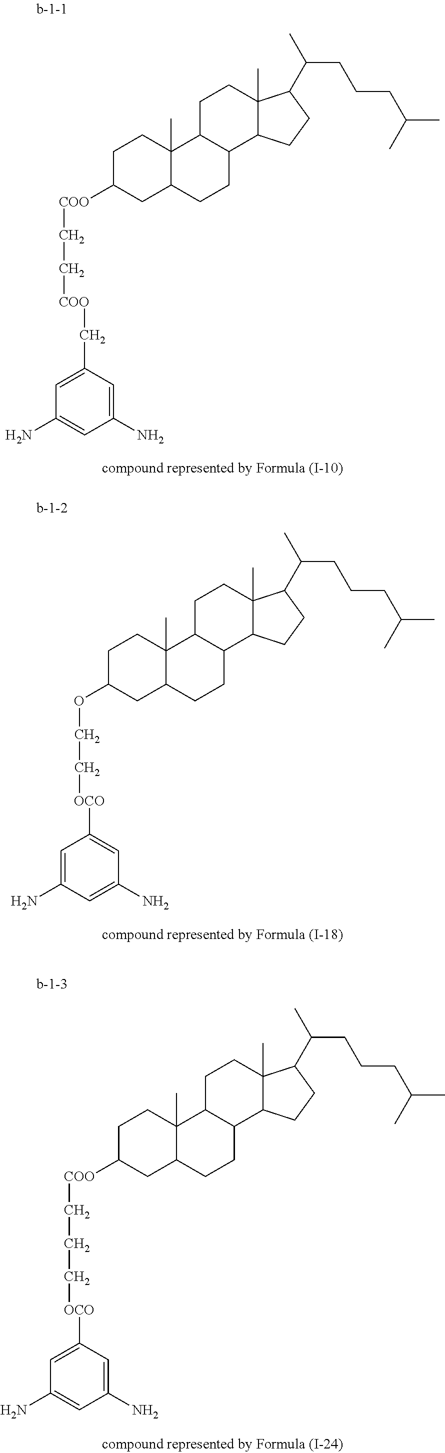

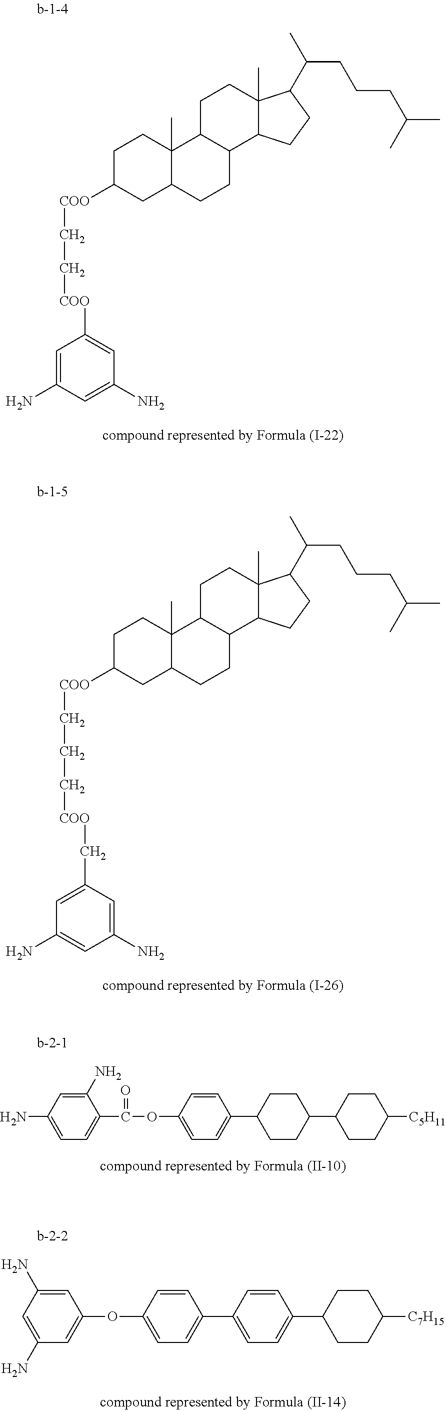

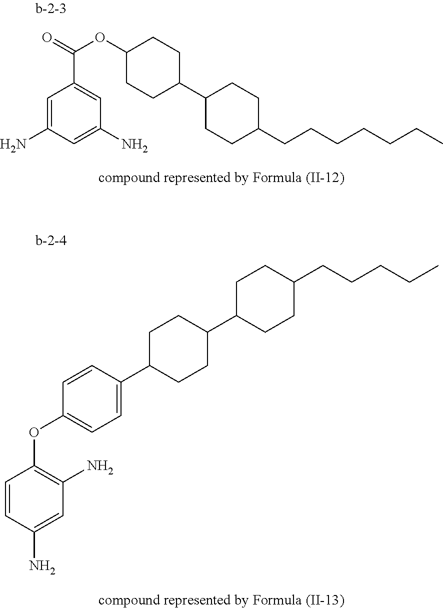 [SMILES: CCCCCCCC1CCC(C2CCC(OC(=O)c3cc(N)cc(N)c3)CC2)CC1 ; CCCCCC1CCC(C2CCC(c3ccc(Oc4ccc(N)cc4N)cc3)CC2)CC1]

b-3-1 p-diaminobenzene
b-3-2 4,4′-diaminodiphenylmethane

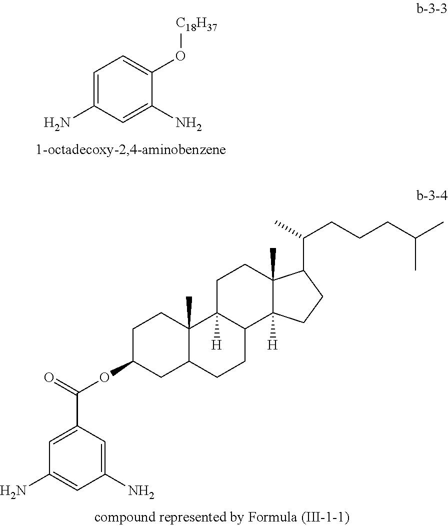

b-3-5 4,4′-methylenebis(cyclohexylamine)
b-3-6 1,4-diaminocyclohexane

### <Preparation of Liquid Crystal Alignment Agent>

Examples 1 to 15 and Comparative Examples 1 to 7 of the liquid crystal alignment agent are shown in Table 3 and Table 4.

### EXAMPLE 1

100 parts by weight of the polymer composition (A) was added in 1000 parts by weight of N-methyl-2-pyrrolidon (hereafter referred as B-1) and 600 parts by weight of ethylene glycol n-butyl ether (hereafter referred as B-2) and mixed to dissolve at the room temperature to form a liquid crystal alignment agent. The resulted polymer composition was evaluated according to the following evaluation methods, and the results thereof are listed in Table 3. The evaluation method of the moisture absorption is described as follows.

### EXAMPLES 2 TO 15 AND COMPARATIVE EXAMPLES 1 TO 7

The Examples 2 to 15 and Comparative Examples 1 to 7 are similar to Example 1 with the modifications of various kinds and amounts of the compositions for the liquid crystal alignment agent. The formulations and evaluation results thereof are listed in Table 3 and Table 4 and are not repeated herein.

TABLE 3

| | | Examples | | | | | | | | | | | | | | |
|---|---|---|---|---|---|---|---|---|---|---|---|---|---|---|---|---|
| Component (parts by weight) | | 1 | 2 | 3 | 4 | 5 | 6 | 7 | 8 | 9 | 10 | 11 | 12 | 13 | 14 | 15 |
| polymer | A-1-1 | 100 | | | | | | | | | | | | | | |
| composition (A) | A-1-2 | | 100 | | | | | | | | | | | | | |
| | A-1-3 | | | 100 | | | | | | | | | | | | |
| | A-1-4 | | | | 100 | | | | | | | | | | | |
| | A-1-5 | | | | | 100 | | | | | | | | | | |
| | A-2-1 | | | | | | 100 | | | | | | | | | |
| | A-2-2 | | | | | | | 100 | | | | | | | | |
| | A-2-3 | | | | | | | | 100 | | | | | | | |
| | A-2-4 | | | | | | | | | 100 | | | | | | |
| | A-2-5 | | | | | | | | | | 100 | | | | | |
| | A-2-6 | | | | | | | | | | | 100 | | | | |
| | A-2-7 | | | | | | | | | | | | 100 | | | |
| | A-2-8 | | | | | | | | | | | | | 100 | | |
| | A-2-9 | | | | | | | | | | | | | | 50 | |
| | A-2-10 | | | | | | | | | | | | | | 50 | 100 |
| | A-3-1 | | | | | | | | | | | | | | | |
| | A-3-2 | | | | | | | | | | | | | | | |
| | A-3-3 | | | | | | | | | | | | | | | |
| | A-3-4 | | | | | | | | | | | | | | | |
| | A-3-5 | | | | | | | | | | | | | | | |
| | A-3-6 | | | | | | | | | | | | | | | |
| | A-3-7 | | | | | | | | | | | | | | | |
| solvent (B) | B-1 | 1000 | 800 | | 800 | 1000 | | | 900 | 1200 | | | 400 | 800 | | 1200 |
| | B-2 | 600 | | 1600 | 800 | | 1500 | 800 | | | 1000 | | 500 | 750 | 1200 | 200 |
| | B-3 | | 1000 | | | 500 | | 400 | 500 | | 250 | 1600 | 400 | | 250 | |
| additive (C) | C-1 | | | | | | | 5 | | | | 2 | | | | |
| | C-2 | | | 10 | | | | | | | | 3 | | | 2 | |
| evaluation | moisture | ◯ | ◯ | ◯ | ◯ | ◯ | ◯ | ⊚ | ⊚ | ⊚ | ⊚ | ◯ | ◯ | ◯ | ◯ | ◯ |
| | absorption | | | | | | | | | | | | | | | |

TABLE 4

| Component | | Comparative Examples | | | | | | |
|---|---|---|---|---|---|---|---|---|
| (parts by weight) | | 1 | 2 | 3 | 4 | 5 | 6 | 7 |
| polymer | A-1-1 | | | | | | | |
| composi- | A-1-2 | | | | | | | |
| tion (A) | A-1-3 | | | | | | | |
| | A-1-4 | | | | | | | |
| | A-1-5 | | | | | | | |
| | A-2-1 | | | | | | | |
| | A-2-2 | | | | | | | |
| | A-2-3 | | | | | | | |
| | A-2-4 | | | | | | | |
| | A-2-5 | | | | | | | |
| | A-2-6 | | | | | | | |
| | A-2-7 | | | | | | | |
| | A-2-8 | | | | | | | |
| | A-2-9 | | | | | | | |
| | A-2-10 | | | | | | | |
| | A-3-1 | 100 | | | | | | |
| | A-3-2 | | 100 | | | | | |
| | A-3-3 | | | 100 | | | | |
| | A-3-4 | | | | 100 | | | |
| | A-3-5 | | | | | 100 | | |
| | A-3-6 | | | | | | 100 | |
| | A-3-7 | | | | | | | 100 |
| solvent | B-1 | 1000 | | | 1400 | 750 | 100 | 1500 |
| (B) | B-2 | 500 | 800 | 1600 | | 750 | 1200 | |
| | B-3 | | 800 | | | | 100 | |
| additive | C-1 | | | | | | | |
| (C) | C-2 | | 10 | | | | | |
| evaluation | moisture | X | X | X | X | X | X | X |
| | absorption | | | | | | | |

### In Table 3 and Table 4:

B-1 N-methyl-2-pyrrolidinone (NMP)
B-2 ethylene glycol n-butyl ether
B-3 N,N-dimethylacetamide
C-1 N,N,N′,N′-tetraglycidyl-4,4′-diaminodiphenylmethane
C-2 N,N-diglycidyl-p-glycidoxy aniline

### <Evaluation>

### Imidization Ratio:

The imidization ratio refers to a ratio of the number of imide ring in the total amount of the number of amic acid functional group and the number of imide ring, and the imidization ratio is presented by percentage.

After reduced pressure drying the polymer compositions (A) of Synthesis Examples A-1-1 to A-2-10 and Comparative Synthesis Examples A-3-1 to A-3-7, respectively, the polymer compositions (A) were dissolved in a suitable deuteration solvent, such as dimethyl sulfoxide. ¹H-NMR (hydrogen-nuclear magnetic resonance) was detected at the room temperature (25° C.) using tetramethylsilane as a standard, and the imidization ratio (%) was calculated according to the following formula (VII):

$$Imidization Ratio ( \% ) = [ 1 - \frac{Δ 1}{Δ 2 \times α} ] \times 100 \% \qquad ( VII )$$

In the formula (VII), Δ1 is the peak area of the chemical shift induced by the proton of NH group near 10 ppm, Δ2 is the peak area of other proton, and a is the ratio of one proton of NH group corresponding to the number of other proton in the polyamic acid precursor.

Moisture absorption:

The long-term printability of the liquid crystal alignment agents of the aforementioned Examples and Comparative Examples was evaluated by a printer (made by Nissha Printing Co. LTD., and the trade name is Angstromer S-15). Printing plates of the printer were 400-mesh of APR plates, and the printing condition was 3.6 mm nip width and 5 seconds of tack time. In the evaluating method of the long-term printability, the liquid crystal alignment agents were printed on a glass substrate, and the glass substrate is 100 mm×100 mm The liquid crystal alignment film was observed by how much time it takes to turn into opaque. The evaluation standards are as follows.

⊚: time>60 minutes

∘: 60 minutes≧time>30 minutes

Δ: 30 minutes≧time>15 minutes

×: time≦15 minutes

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A liquid crystal alignment agent comprising:
a polymer composition (A) obtained by reacting a mixture comprising a tetracarboxylic dianhydride component (a) and a diamine component (b); and
a solvent (B);
wherein the diamine component (b) comprises at least one diamine compound (b-1) represented by Formula (I), and at least one diamine compound (b-2) represented by Formula (II): 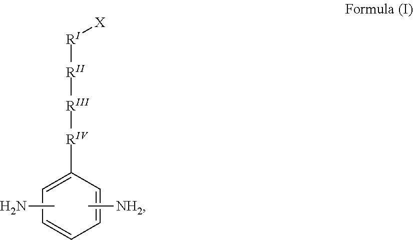
in Formula (I):
R^{I} and R^{III} each independently represent an ether group, a thioether group, a thioester group or an ester group, wherein the orientation of the thioester group or the ester group is not limited;
R^{II} is a C₂-C₁₀ alkylene group;
R^{IV} is a single bond, a methylene group or an ethylene group; and
X is a C₁₇-C₄₀ monovalent organic group having a steroid frame;
in Formula (II): 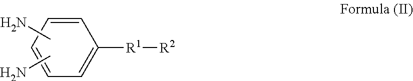
R¹ represents 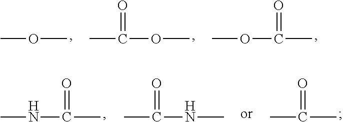
R² represents an organic group represented by Formula (II-1); 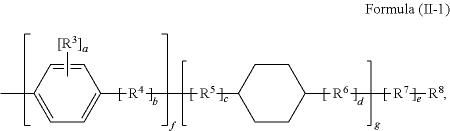
in Formula (II-1):
R³ represents a hydrogen atom, a fluorine atom or a methyl group;
R⁴, R⁵ or R⁶ each independently represent a single bond, 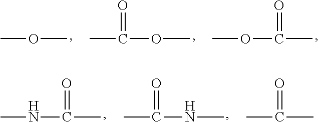
or a C₁-C₃ alkylene group;
R⁷ represents 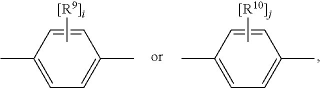
wherein R⁹ and R¹⁰ each independently represent a hydrogen atom, a fluorine atom or a methyl group;
R⁸ represents a hydrogen atom, a fluorine atom, a C₁-C₁₂ alkyl group, a C₁-C₁₂ fluoroalkyl group, a C₁-C₁₂ alkoxy group, —OCH₂F, —OCHF₂ or —OCF₃;
a represents 1 or 2;
b, c and d each independently represent an integer from 0 to 4;
e, f and g each independently represent an integer from 0 to 3, and e+f+g≧3;
i and j each independently represent 1 or 2; and
when R³, R⁴, R⁵, R⁶, R⁷, R⁸, R⁹ or R¹⁰ is plural, R³, R⁴, R⁵, R⁶, R⁷, R⁸, R⁹ or R¹⁰ respectively is the same or different.

2. The liquid crystal alignment agent according to claim 1, wherein based on 100 moles of the used amount of the diamine component (b), the used amount of the diamine compound (b-1) represented by Formula (I) is from 10 to 50 moles; the used amount of the diamine compound (b-2) represented by Formula (II) is from 1 to 15 moles.

3. The liquid crystal alignment agent according to claim 1, wherein the diamine component (b) further comprises an other diamine compound (b-3), wherein the other diamine compound (b-3) comprises a cycloaliphatic diamine compound.

4. The liquid crystal alignment agent according to claim 3, wherein based on 100 moles of the used amount of the diamine component (b), the used amount of the other diamine compound (b-3) is from 35 to 89 moles.

5. The liquid crystal alignment agent according to claim 1, wherein the molar ratio of the diamine compound (b-1) represented by Formula (I) and the diamine compound (b-2) represented by Formula (II) is 2 to 8.

6. The liquid crystal alignment agent according to claim 5, wherein the molar ratio of the diamine compound (b-1) represented by Formula (I) and the diamine compound (b-2) represented by Formula (II) is 3 to 8.

7. The liquid crystal alignment agent according to claim 6, wherein the molar ratio of the diamine compound (b-1) represented by Formula (I) and the diamine compound (b-2) represented by Formula (II) is 3 to 7.

8. The liquid crystal alignment agent according to claim 1, wherein the imidization ratio of the polymer composition (A) ranges from 30% to 90%.

9. A liquid crystal alignment film made by the liquid crystal alignment agent according to claim 1.

10. A liquid crystal display element comprising the liquid crystal alignment film according to claim 9.
